(19) United States
(12) Patent Application Publication
(10) Pub. No.: US 2013/0135323 A1
(43) Pub. Date: May 30, 2013

(54) METHOD AND DEVICE FOR PROVIDING INFORMATION

(71) Applicants: Ka-won CHEON, Seoul (KR); Choon-kyoung MOON, Yongin-si (KR); Seong-hoon KANG, Suwon-si (KR)

(72) Inventors: Ka-won CHEON, Seoul (KR); Choon-kyoung MOON, Yongin-si (KR); Seong-hoon KANG, Suwon-si (KR)

(73) Assignee: Samsung Electronics Co., Ltd., Suwon-si (KR)

(21) Appl. No.: 13/604,065

(22) Filed: Sep. 5, 2012

(30) Foreign Application Priority Data
Nov. 30, 2011 (KR) 10-2011-0127228

(51) Int. Cl. G06T 1/00

(52) U.S. Cl. 345/501

(57) ABSTRACT

An information providing method and device capable of improving accessibility to information. The method includes producing a piece of data based on user activity in a device; and displaying information based on the piece of data on the device.

### PRIORITY

This application claims priority under 35 U.S.C. §119(a) to Korean Patent Application No. 10-2011-0127228, which was filed on Nov. 30, 2011 in the Korean Intellectual Property Office, the entire disclosure of which is incorporated herein by reference.

### BACKGROUND OF THE INVENTION

1. Field of the Invention

The present invention relates generally to providing information, and more particularly, to providing information produced based on the operation of a device.

2. Description of the Related Art

Recently, as smartphone technology has been developing, the various functions of devices have been increasing. Thus, types of information or content that is produced in devices have also been increasing. Accordingly, there is a need to develop a technique to efficiently access various types of information or content.

When information is shared between devices, a technique of efficiently accessing the shared information is also needed. However, in some information sharing techniques, because information that a user wants to share is detected by a connection between the devices, accessibility to a desired file is low and information that is shared between devices is limited to information stored in the devices when the devices are connected to one another.

### SUMMARY OF THE INVENTION

Accordingly, the present invention has been made to solve the above-stated problems occurring in the prior art, and an aspect of the present invention provides a method and device for providing information based on user activity in a device to improve accessibility to information and/or content.

Another aspect of the present invention provides a method and device for providing multi-summary information or summary information produced based on user activity in a device.

Another aspect of the present invention provides a method and device for providing information produced based on user activity in a device, in real time.

Another aspect of the present invention provides a method and device for providing information from a multi-device in an integrated manner to improve accessibility to information shared between devices.

Another aspect of the present invention provides a method and device for providing multi-summary information or summary information from a multi-device in an integrated manner to improve accessibility to information shared between devices and diversify types of information that is shared between the devices.

Another aspect of the present invention provides a method and device for providing multi-information produced based on user activities in multi-devices in such a manner that the multi-information is integrated and viewed in one device in real time.

Another aspect of the present invention provides a method and device for providing multi-information received from multi-devices belonging to the same group in an integrated manner.

Another aspect of the present invention provides a method and device for selectively providing multi-information received from multi-devices belonging to the same group in an integrated manner.

According to an aspect of the present invention, a method of providing information is provided. The method includes producing a piece of data based on user activity in a device; and displaying information based on the piece of data on the device. According to another aspect of the present invention, a device for providing information is provided. The device includes a processor for collecting a piece of data produced based on user activity and producing information based on the collected data; and an output unit for outputting the information.

### BRIEF DESCRIPTION OF THE DRAWINGS

The above and other aspects, features and advantages of the present invention will become more apparent by describing in detail embodiments thereof with reference to the attached drawings in which:

FIG. 1 is a block diagram illustrating a network consisting of a plurality of devices, according to an embodiment of the present invention;

FIG. 2 is a table illustrating user activity occurs and content and/or information that is produced in a plurality of devices, according to an embodiment of the present invention;

FIG. 3 is a block diagram illustrating a device according to an embodiment of the present invention;

FIG. 4 illustrates a software structure of an application that executes a method of providing information, according to an embodiment of the present invention;

FIG. 5 illustrates roles of some of the elements included in the software structure illustrated in FIG. 4, according to an embodiment of the present invention

FIG. 6 is a table illustrating particular information about the content or information produced by monitoring user activity, according to an embodiment of the present invention;

FIG. 7 is a block diagram illustrating the processor of FIG. 3 based on the software structure of FIG. 4, according to an embodiment of the present invention;

FIG. 8 is a flowchart illustrating a method of providing information, according to an embodiment of the present invention;

FIGS. 9A to 9M illustrate screen images each containing integrated information, according to embodiments of the present invention;

FIG. 10 is a flowchart illustrating steps performed between two devices, based on the flowchart of FIG. 8, according to an embodiment of the present invention;

FIG. 11 is a flowchart illustrating a method of providing information, according to another embodiment of the present invention;

FIG. 12 is a flowchart illustrating steps performed between two devices, based on the flowchart of FIG. 11, according to another embodiment of the present invention;

FIG. 13 is a flowchart illustrating steps performed between two devices, in a method of providing information according to an embodiment of the present invention;

FIG. 14 is a flowchart illustrating a process of storing data produced according to user activity, in a method of providing information, according to an embodiment of the present invention;

FIG. 15 is a flowchart illustrating a process of using content or information, in a method of providing information, according to an embodiment of the present invention;

FIGS. 16A and 16B illustrate screen images via which content produced according to user activity is provided to a user, based on the method of FIG. 15, according to embodiments of the present invention;

FIG. 17 illustrates a process of processing information regarding connected devices, in a method of providing information, according to an embodiment of the present invention;

FIG. 18 is a block diagram illustrating a network consisting of a plurality of devices, according to another embodiment of the present invention; and

FIG. 19 is a flowchart illustrating a method of providing information, according to another embodiment of the present invention.

### DETAILED DESCRIPTION OF EMBODIMENTS OF THE PRESENT INVENTION

Hereinafter, various embodiments of the present invention will be described with reference to the accompanying drawings. Like reference numerals denote like elements throughout the drawings.

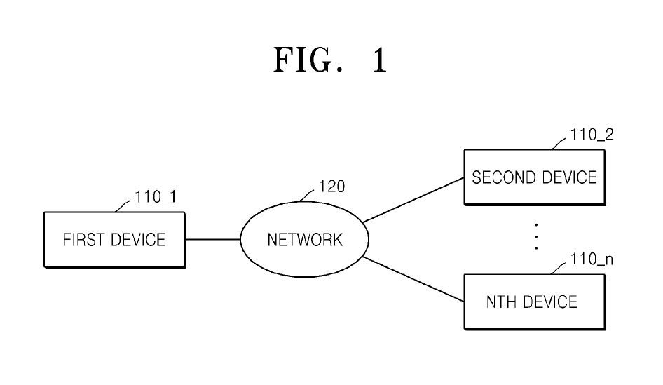

FIG. 1 is a block diagram of a network 120 including a plurality of first to n^{th} devices 110_1 to 110_{—}n, according to an embodiment of the present invention. The plurality of first to n^{th} devices 110_1 to 110_{—}n are devices that establish communication with one another via the network 120. Examples of the plurality of first to n^{th} devices 110_1 to 110_{—}n include a smartphone, a smart TeleVision (TV), a Personal Computer (PC), a desktop PC, a notebook computer, a desktop computer, a smart board, a tablet PC, a slate PC, a digital camera, a digital photo frame, a mobile device, and a Personal Digital Assistant (PDA), but are not limited thereto.

According to an embodiment of the present invention, when at least two devices from among the plurality of first to n^{th} devices 110_1 to 110_{—}n are connected via the network 120, the at least two devices share multi-information of a multi-device and provide the multi-information to a user.

In other words, according to an embodiment of the present invention, the first device 110_1 displays integrated information based on at least one piece of data produced by the first device 110_1 itself and at least one piece of data produced by a device connected to the first device 110_1 from among the second to n^{th} devices 110_2 to 110_{—}n via the network 120. The device connected to the first device 110_1 displays the integrated information displayed on the first device 110_1. The displaying of the integrated information outputs the integrated information.

The second device 110_2 displays integrated information based on at least one piece of data produced by the second device 110_2 itself and at least one piece of data produced by a device connected to the second device 110_2 from among the first device 110_1 and the third to n^{th} devices 110_3 to 110_{—}n via the network 120. The device connected to the second device 110_2 displays the integrated information displayed on the second device 110_2.

The n^{th} device 110_{—}n displays integrated information based on at least one piece of data produced by the n^{th} device 110_{—}n itself and at least one piece of data produced by a device connected to the n^{th} device 110_{—}n from among the first to (n−1)^{th} devices 110_1 to 110_{—}n−1 via the network 120. The device connected to the n^{th} device 110_{—}n displays the integrated information displayed in the n^{th} device 110_{—}n.

Moreover, each of the plurality of first to n^{th} devices 110_1 to 110_{—}n displays information based on at least one piece of data produced by itself. For example, the first device 110_1 displays information based on at least one piece of data produced by the first device 110_1 itself. The displayed information is referred to as integrated information. However, the integrated information based on the at least one piece of data produced by the first device 110_1 is multi-information based on a multi-operation of the first device 110_1. Examples of the multi-operation include photographing, shooting a moving picture, storing or reproducing a moving picture, recording a sound source, storing or reproducing music, storing information, accessing the Internet, installing an application, and running the application. Each of the second to n^{th} devices 110_2 to 110_{—}n displays the information based on the at least one piece of data produced by, for example, the first device 110_1.

Data produced by each of the plurality of first to n^{th} devices 110_1 to 110_{—}n include metadata of content and/or information, which is obtained by monitoring user activity in each of the plurality of first to n^{th} devices 110_1 to 110_{—}n. Examples of the content include media content, such as a picture, video, and audio. A picture includes a photograph, video includes a moving picture, and audio includes music. Examples of the information includes web page information, application information, memo information, calendar information, and information regarding a device that provides displayed information. If information displayed in each of the plurality of first to n^{th} devices 110_1 to 110_{—}n is based on data produced therein, then the information does not include information regarding the device that provides displayed information. User activity is monitored when each of the plurality of first to n^{th} devices 110_1 to 110_{—}n performs an operation to obtain content and/or information, e.g., photographing, shooting a moving picture, storing or reproducing a moving picture, recording a sound source, storing or reproducing music, storing information, accessing the Internet, installing or running an application, and selecting or excluding an information providing device.

Information displayed in each of the plurality of first to n^{th} devices 110_1 to 110_{—}n (“integrated information”) is based on data about content and/or information obtained by monitoring user activity therein, and is sorted according to a criterion for providing a fast access path (or fast accessibility) to content and/or information that is likely to be used by a user. The integrated information is referred to as summary information, multi-summary information, user activity information, or live information. Criteria for providing the integrated information includes at least one from among a point in time at which user activity occurs, a frequency of using content and/or information, and a user's preference for the content and/or information, but is not limited thereto.

For example, if content and/or information that have recently been produced according to user activity are likely to be used by a user, then the integrated information is sorted based on recent points of time. In other words, if the criterion for providing the integrated information is recent points of time, then the integrated information is obtained by sorting data about content and/or information that was most recently produced, in a first place. If content and/or information that are very frequently used by a user, then the integrated information is sorted based on the frequency of use. That is, if this criterion is frequently used, the integrated information is obtained by sorting data about content and/or information that are the most frequency used, in the first place. If content and/or information that are highly preferred by users are highly likely to be used by a user, then the integrated information is sorted based on user preference. In other words, the integrated information is obtained by sorting data by content and/or information that are most preferred.

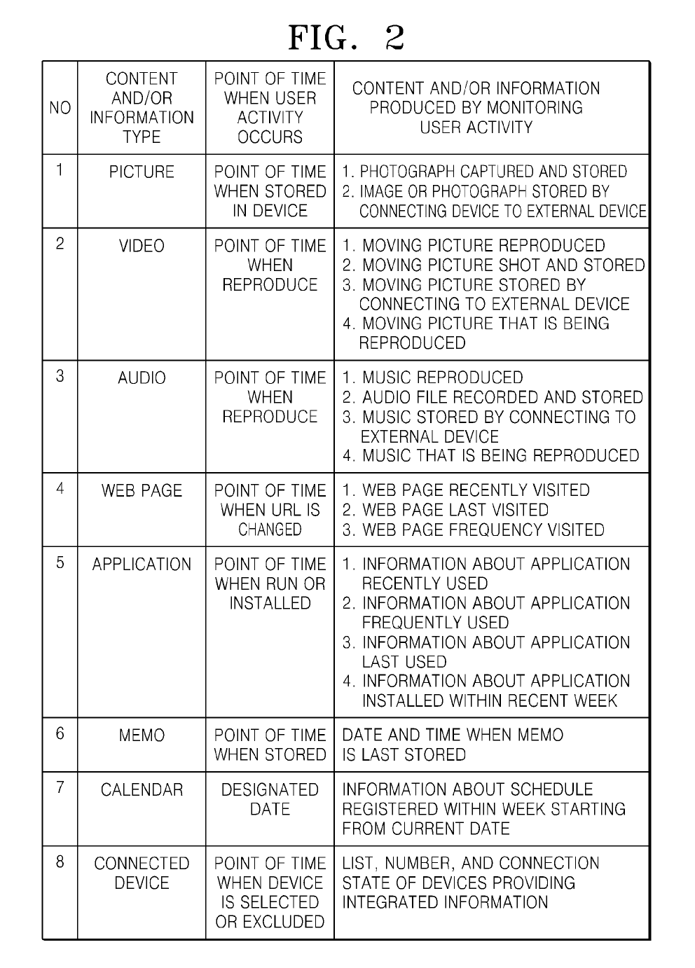

FIG. 2 is a table illustrating examples of a point in time at which user activity occurs and content and/or information that is produced in the plurality of first to n^{th} devices 110_1 to 110_{—}n of FIG. 1, according to an embodiment of the present invention. Referring to FIG. 2, if the type of content and/or information is a picture and a point in time at which user activity occurs is when content and/or information is stored or produced in a device, then content and/or information that is obtained by monitoring user activity include a photograph captured and stored in the device, and an image or a photograph stored in the device by connecting the device to an external device.

If the type of content and/or information is video and a point in time at which user activity occurs is when reproducing of content and/or information starts, then content and/or information that is obtained by monitoring user activity include a moving picture reproduced in a device, a moving picture shot and stored in the device, a moving picture stored in the device by connecting the device to an external device, and a moving picture that is being reproduced in a current device. The current device means a device that a user is currently using, and may also be referred as a local device or my device. Hereinafter, the current device will be referred to as a local device.

If the type of content and/or information is audio and a point in time at which user activity occurs is when reproducing of content and/or information starts, then content and/or information that is obtained by monitoring user activity include music reproduced in a device, an audio file stored in the device by recording a sound source, music stored in the device by connecting the device to an external device, and music that is being reproduced in a local device.

If the type of content and/or information is a web page and a point in time at which user activity occurs is when a Uniform Resource Locator (URL) is changed, then content and/or information that is obtained by monitoring user activity include a web page that was recently visited using a device, a web page that was last visited using the device, and a web page that is frequently visited using the device.

If the type of content and/or information is an application and a point in time at which user activity occurs is when an application is run or installed, then content and/or information that is obtained by monitoring user activity include information about an application that was recently used in a device, an application that is frequently used in the device, an application that was last used in the device, and an application that was installed within the last week.

If the type of content and/or information is a memo and a point in time at which user activity occurs is when a memo is stored, then content and/or information that is obtained by monitoring user activity include information about a date and time when the memo was last stored in a device.

If the type of content and/or information is a calendar and a point in time at which user activity occurs is determined by a designated date, then content and/or information that is obtained by monitoring user activity include information about a schedule registered with a device within a week starting from a current date.

If the type of content and/or information is a connected device and a point in time at which user activity occurs is when a device is selected or excluded, then content and/or information that is obtained by monitoring user activity include a list of devices that provide integrated information, the number of the devices, and information about a connection state between the devices.

The type of content and/or information, a point in time at which user activity occurs, and content and/or information that is obtained by monitoring user activity, according to an embodiment of the present invention, are not limited to those illustrated in FIG. 2. Examples of devices described in the table of FIG. 2 include a plurality of first to n^{th} devices 110_1 to 110_{—}n of FIG. 1.

A plurality of first to n^{th} devices 110_1 to 110_{—}n are devices grouped based on user IDentification (ID) information. That is, the plurality of first to nth devices 110_1 to 110_{—}n are devices grouped to be logged in to applications, which are loaded in the plurality of first to n^{th} devices 110_1 to 110_{—}n, respectively, to perform a method of providing information according to an embodiment of the present invention, by using the same user ID information. Thus, the present invention provides an environment in which not only information stored in a device of a user but also information stored in another person's device is used in one device, and an environment in which a user who owns multi-devices may use a plurality of pieces of information being respectively produced or stored in the multi-devices, in one device. If information is provided from a multi-device, a method of providing information according to an embodiment of the present invention is referred to as a method of sharing information provided from a multi-device. The present invention further provides an environment in which information produced or stored in a device is used in a desired device.

The user ID information includes user name and a password. The user ID information is provided according to a process of providing user ID information by using a wireless communication module, such as Near Field Communication (NFC) or Radio Frequency (RF). An application that executes a method according to an embodiment of the present invention allows not only multi-information to be provided from a device in real time but also multi-information (or multi-summary information) to be shared from a multi-device in real time. Thus, this application is referred to as a live concerto application. A service that is provided to a user by using the live concerto application is referred to as a live concerto service.

Examples of the network 120 of FIG. 1 include a network that supports a wireless Local Area Network (LAN) communication, e.g., Wireless Fidelity (WiFi) or 3^{rd} Generation (3G) communication, and a network based on a wireless communication module, e.g., Bluetooth or Zigbee.

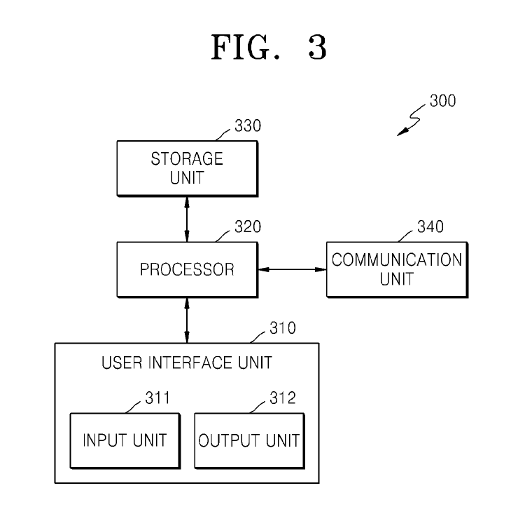

Each of the plurality of first to nth devices 110_1 to 110_{—}n of FIG. 1 include elements as illustrated in FIG. 3. FIG. 3 is a block diagram illustrating a device 300 according to an embodiment of the present invention.

Referring to FIG. 3, the device 300 includes a user interface unit 310, a processor 320, a storage unit 330, and a communication unit 340.

The user interface unit 310 includes an input unit 311 by which an input signal is input, and an output unit 312 by which an output signal is output. The input unit 311 and the output unit 312 are illustrated as independent devices. A user may input information, a command, or data via the input unit 311. According to an embodiment of the present invention, examples of information, a command, or data that is input via the input unit 311 include a command for running an application to perform a method of providing information from a device or providing information to be shared between multi-devices, user ID information, information for selecting integrated information (or integrated multi-information or integrated multi-summary information) displayed on the output unit 312, and screen scroll information.

A signal transmitted/input to the processor 320 via the input unit 311 is referred to as input information, an input command, an input signal, or input data. The input unit 311 is based on a touch interface using a touch panel or a touchscreen. If the input unit 311 is based on the touch interface, the input unit 311 and the output unit 312 is integrated together in one unit.

Examples of the output unit 312 includes, but are not limited to, a Liquid Crystal Display (LCD), a thin film transistor-LCD, an organic light-emitting diode, a flexible display, a Three-Dimensional (3D) display, and Active-Matrix Organic Light-Emitting Diode (AMOLED). The output unit 312 includes a display unit.

The processor 320 controls overall operations of the device 300, and is referred to as a controller, a microprocessor, or the like. The processor 320 operates based on an application for performing a method of providing information according to an embodiment of the present invention. A program for running the application is read from the storage unit 330 or is downloaded from an application store server (not shown) connected via the communication unit 340.

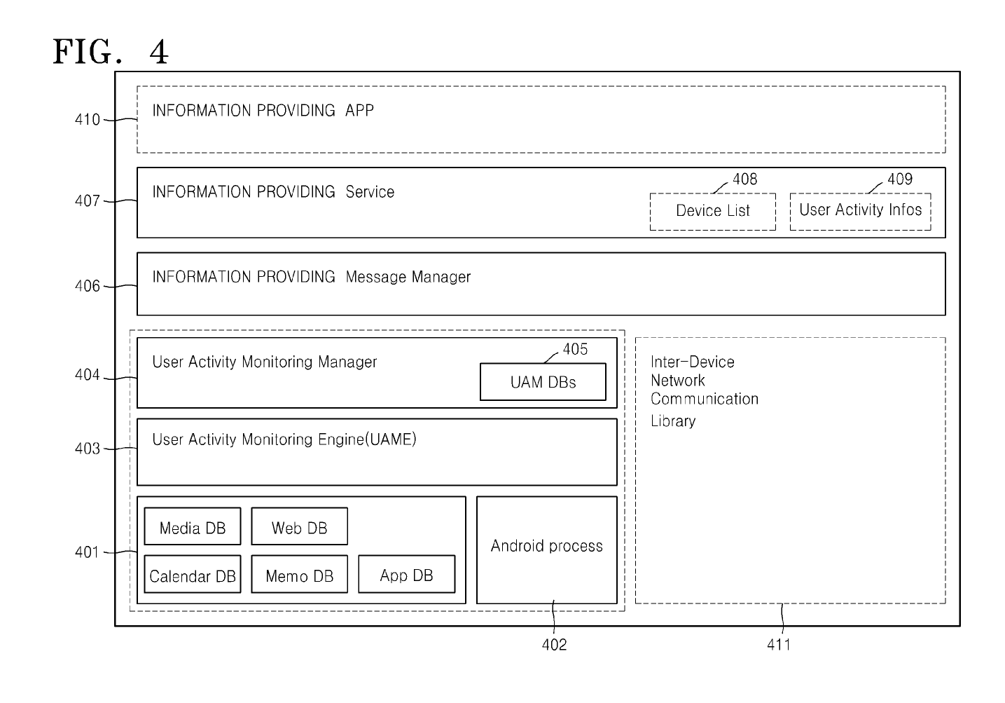

FIG. 4 illustrates a software structure of an application loaded into the processor 320 of FIG. 3 to perform a method of providing information, according to an embodiment of the present invention. Referring to FIG. 4, examples of the software structure include a resource 401 that includes a media DataBase (DB), a web DB, a calendar DB, a memo DB, and an application DB; an Android process 402; a User Activity Monitoring Engine (UAME) 403; a User Activity Monitoring Manager (UAMM) 404; User Activity Monitoring DBs (UAM DBs) 405; an information providing message manager 406; an information providing server 407; a device list 408; user activity information 409; an information-providing application 410; and an inter-device network communication library 411. If the information shared between multi-devices is provided, then the information providing message manager 406, the information providing server 407, and the information-providing application 410 is referred to as an information sharing message manager, an information sharing service, and an information sharing application, respectively.

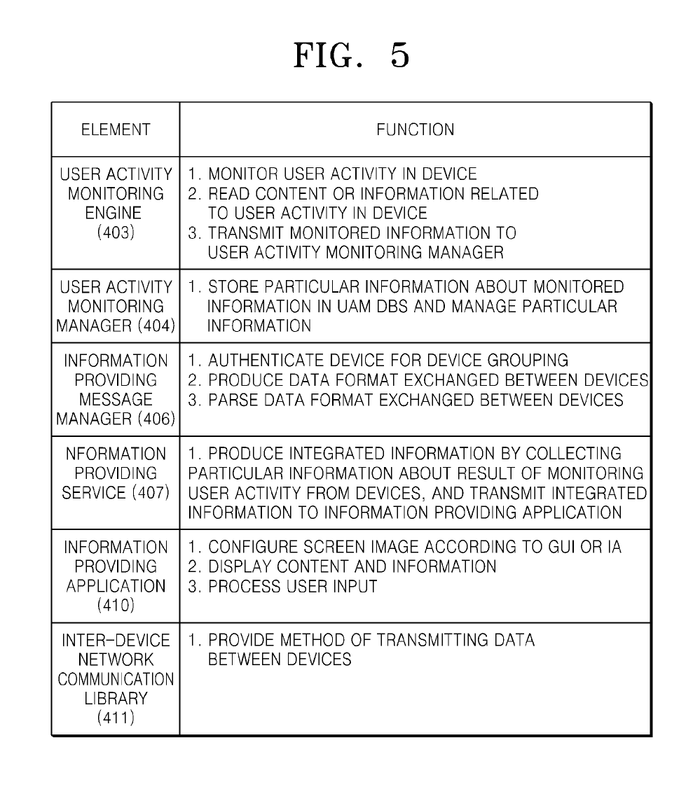

Roles of the elements included in the software structure as illustrated in FIG. 4 is defined as illustrated in FIG. 5. FIG. 5 illustrates the roles of some of the elements included in the software structure of FIG. 4, according to an embodiment of the present invention.

Referring to FIG. 5, the user activity-monitoring engine 403 of FIG. 4 monitors user activity in a device, reads content or information produced according to the user activity, which is obtained by the monitoring, and then transmits the read content or information (or monitored information) to the user activity-monitoring manager 404. The user activity-monitoring engine 403 operates in an activated state when a function of the device that needs user activity to be monitored is used.

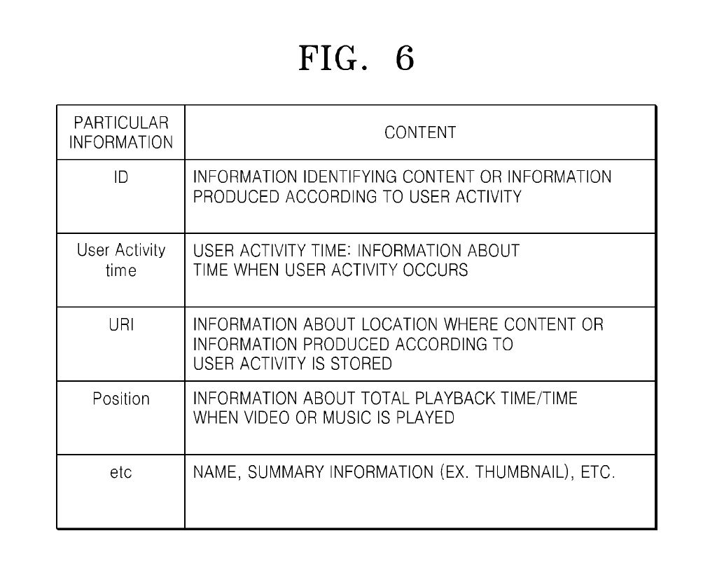

The user activity-monitoring manager 404 receives particular information (or history) regarding content or information, which is produced by monitoring user activity in a local device, from the user activity-monitoring engine 403, stores the particular information in the user activity monitoring DBs 405, and manages the particular information. The particular information stored in the user activity monitoring DBs 405 is referred to as metadata. The particular information includes information illustrated in FIG. 6. FIG. 6 is a table illustrating particular information regarding content or information produced by monitoring user activity, according to an embodiment of the present invention.

Referring to FIG. 6, the particular information includes ID information, user activity time information, Uniform Resource Identifier (URI) information, and position information. The ID information identifies the content or information produced according to the user activity. The user activity time information is information regarding time when the user activity occurred. The URI information is location information of the content or information produced according to the user activity. The position information indicates a total playback time and time when playback occurs when the produced content is video or music. The particular information may also include the name and summary information of the content and/or information produced according to the user activity. The summary information is expressed in the form of thumbnails of the content and/or information but is not limited thereto. However, the particular information is not limited to the information illustrated in FIG. 6.

The information providing message manager 406 performs device authentication to group devices that share information to be provided by the communication unit 340 and the network 120, produces a data format to be transmitted between devices, and parses a received data format.

The information providing service 407 may collect particular information obtained by monitoring user activity in a local device and managed by the user activity-monitoring manager 404, and particular information produced by monitoring user activity, which is received from an external device via the message manager 406; produce integrated information based on the collected particular information; and transmit the integrated information to the information-providing application 410.

Also, the information providing service 407 collects the particular information obtained by monitoring user activity in a local device and managed by the user activity-monitoring manager 404, produces integrated information based on the collected particular information, and transmits the integrated information to the information-providing application 410. Integrated information provided from the local device is based on a result of monitoring at least one user activity related to multi-operations of the local device, as described above. However, if a user uses only one operation of the local device, e.g., a shooting operation, then the integrated information provided from the local device includes a result of monitoring the operation performed in the local device, e.g., a photograph. The information providing service 407 manages the device list 408.

The device list 408 includes device information about a device that provides integrated information from among a plurality of devices connected via the network 120 of FIG. 1. The device information included in the device list 408 includes information about all of the plurality of devices connected via the network 120 and information about the device that provides integrated information from among the plurality of devices. The device that provides the integrated information is a device that provides the integrated information to be output via the output unit 312, and is selected by a user. If the user excludes a device not to provide integrated information from the plurality of devices, then the information providing service 407 may continuously collect particular information that is a result of monitoring user activity in the excluded device when the excluded device is connected through the network 120. If integrated information is based on information collected from a local device, the device list 408 includes only information regarding the local device.

Also, the information providing service 407 forms the user activity information 409 based on collected particular information. The user activity information 409 includes particular information collected by the information providing service 407, and integrated information output via the output unit 312. When a user selects the integrated information output via the output unit 312, the information providing service 407 detects particular information about the selected integrated information by using the user activity information 409, and performs an operation corresponding to the detected particular information.

If selected information is content produced according to user activity occurring in a local device, the information providing service 407 plays the content by using information stored in the user activity monitoring DBs 405. If the selected information is category-selecting information, integrated information belonging to a category selected based on the user activity information 409 is output via the output unit 312. If the selected information is content produced according to user activity occurring in an external device, then the information providing service 407 receives information regarding the selected information from the external device via the communication unit 340, based on the user activity information 409 and then outputs the received information via the output unit 312. Integrated information output via the output unit 312 is the user activity information 409.

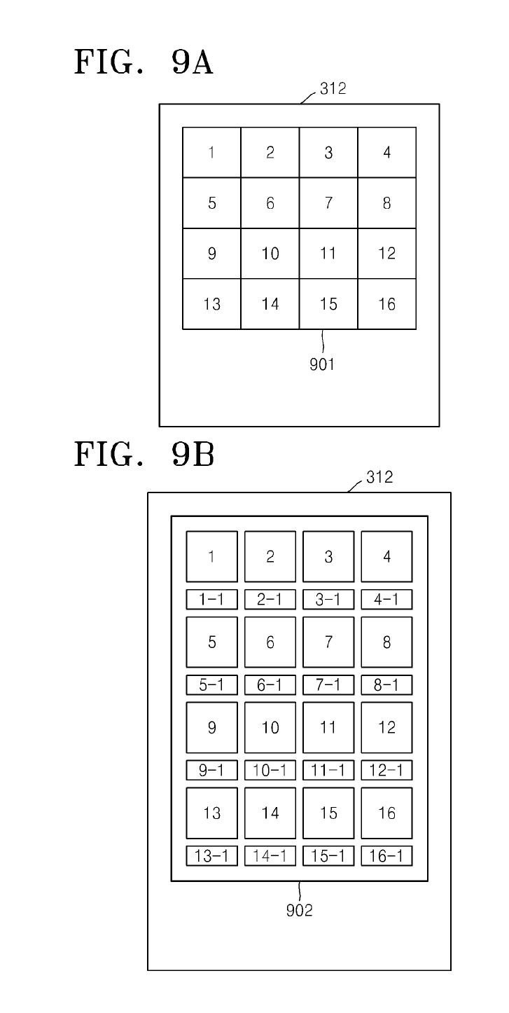

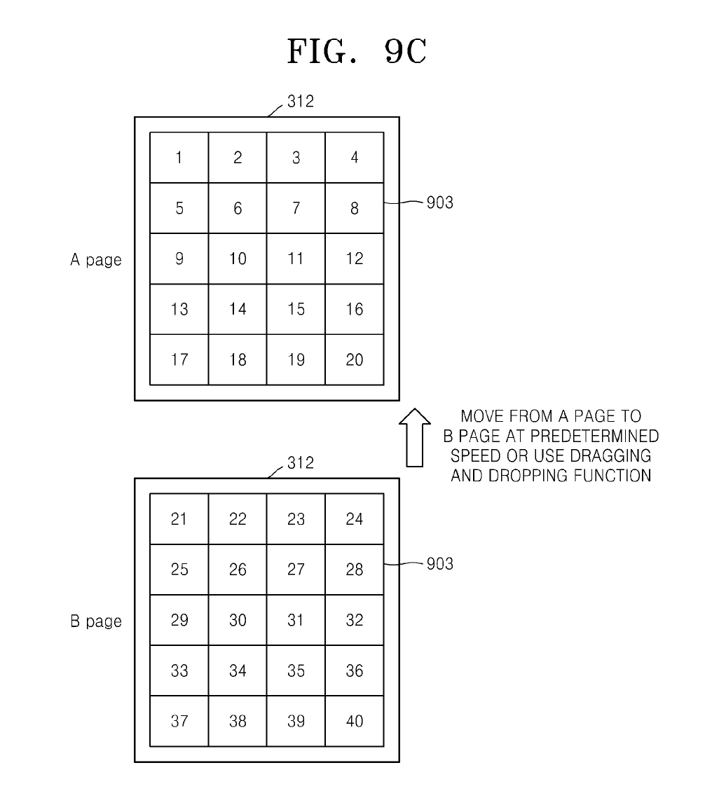

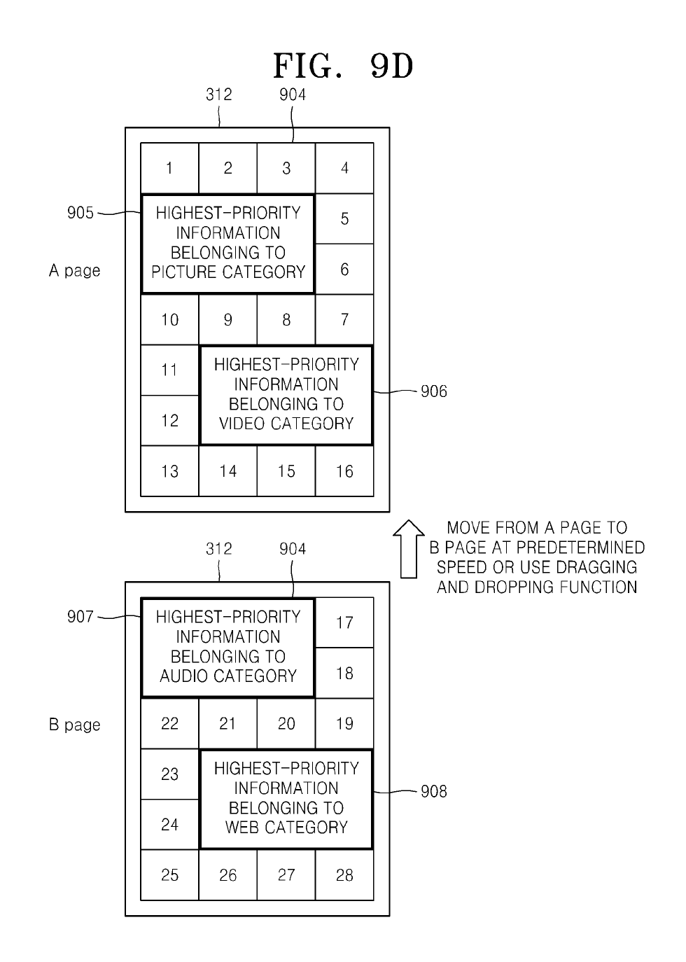

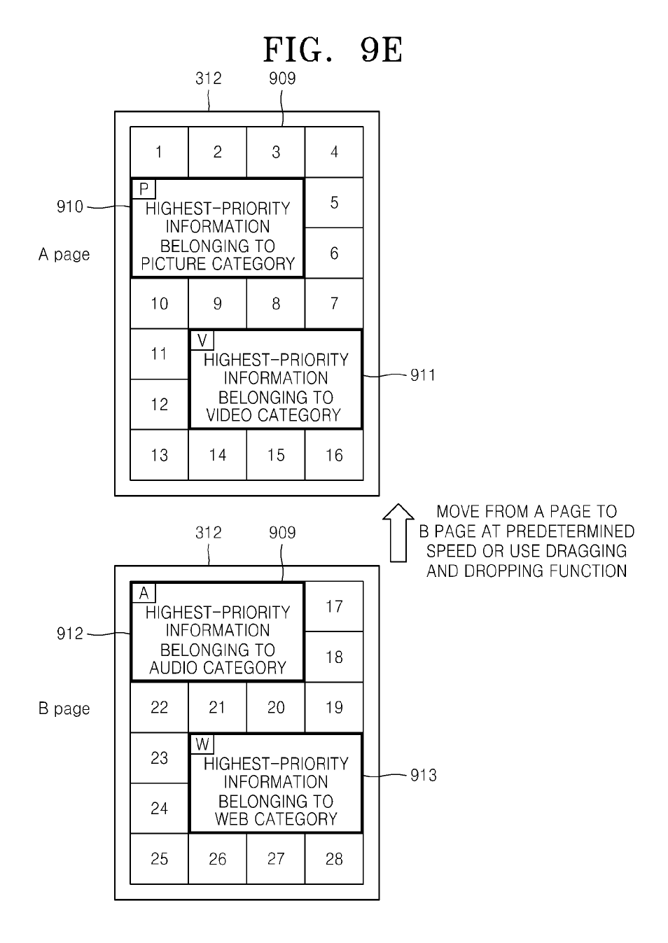

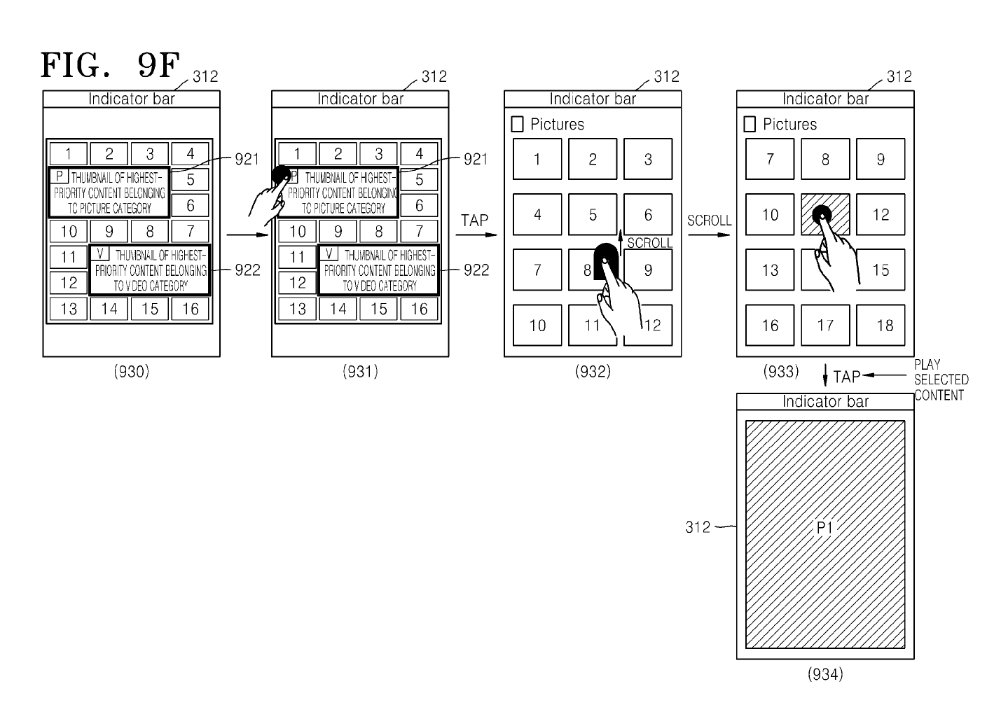

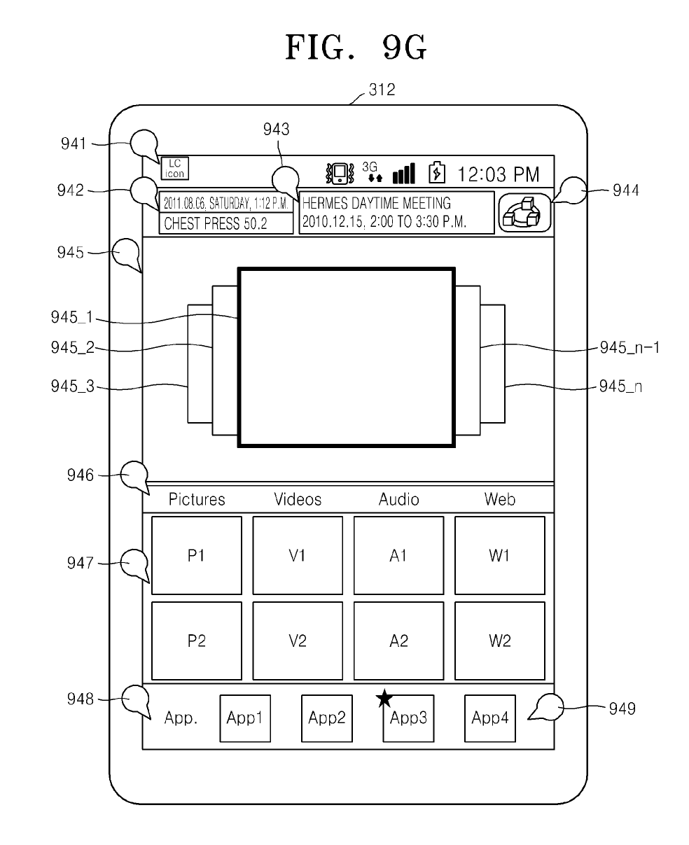

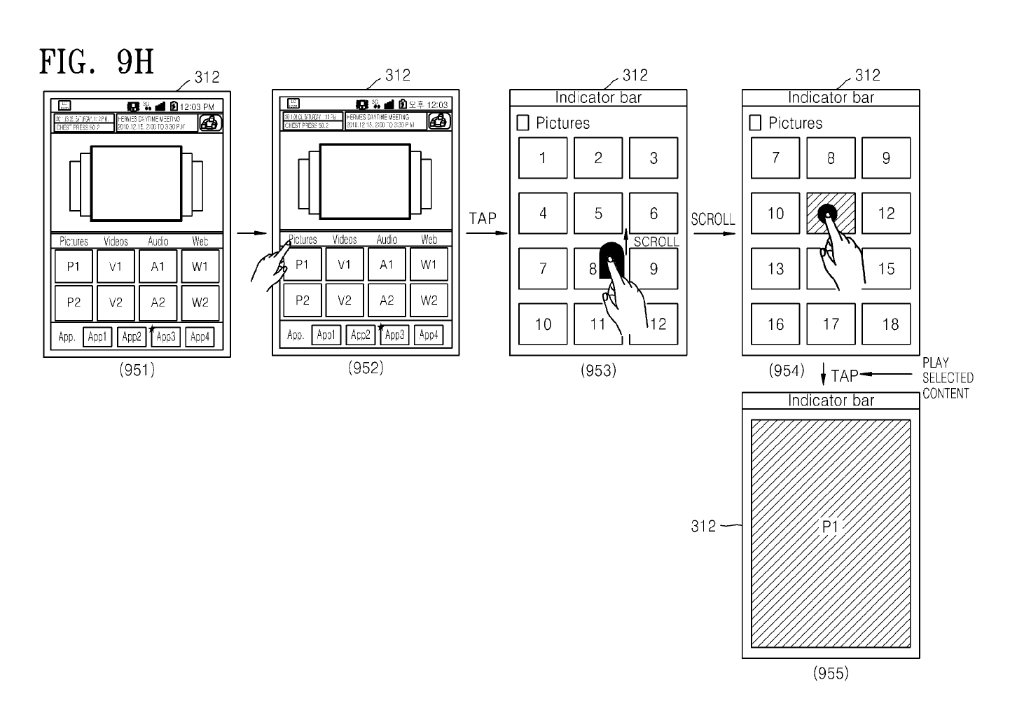

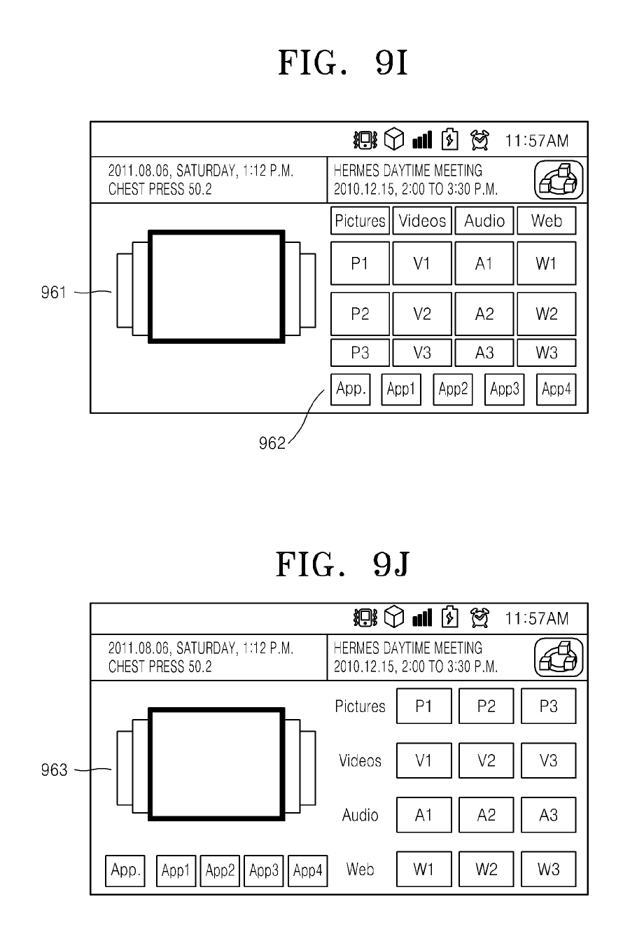

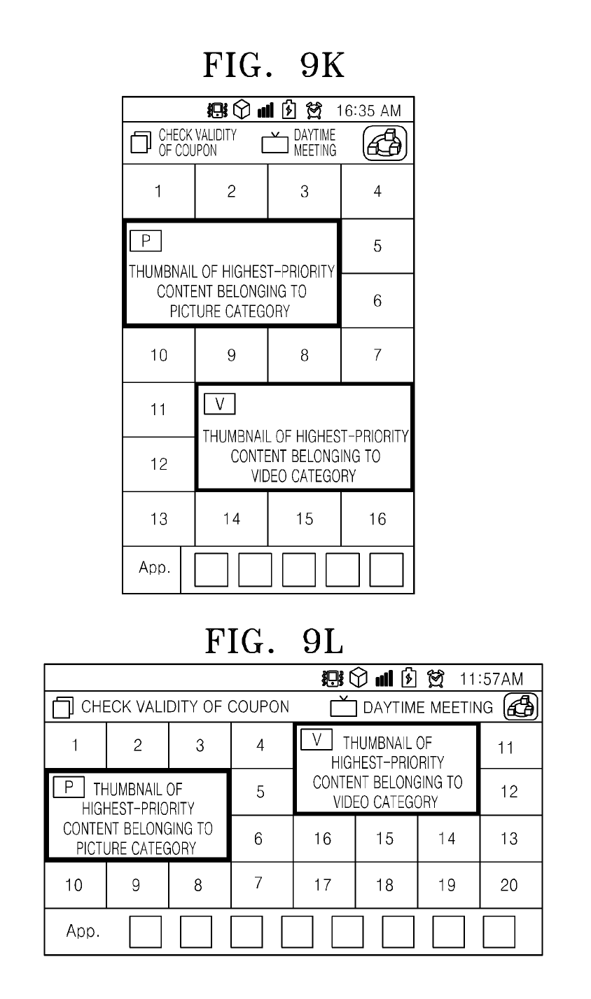

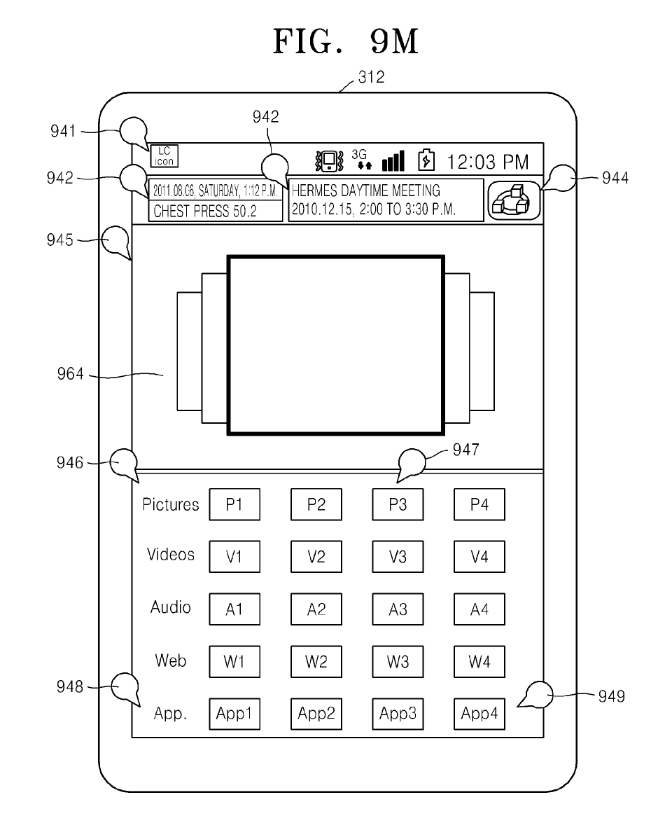

The information-providing application 410 creates a screen image that contains integrated information received from the information providing service 407 so that the screen image is displayed on the output unit 312 of the user interface unit 310, displays the screen image on the output unit 312, and processes information received via the input unit 311. Thus, the information-providing application 410 creates a screen image to contain the integrated information received from the information providing service 407, as will be described in detail with reference to FIGS. 9A to 9M below.

FIG. 4 illustrates the software structure based on the Android process 402, but a process based on, for example, an iPhone Operating System (iOS) or BADA operating system, is used instead of the Android process 402.

Moreover, the software structure of an application providing information according to an embodiment of the present invention is not limited to that illustrated in FIG. 4.

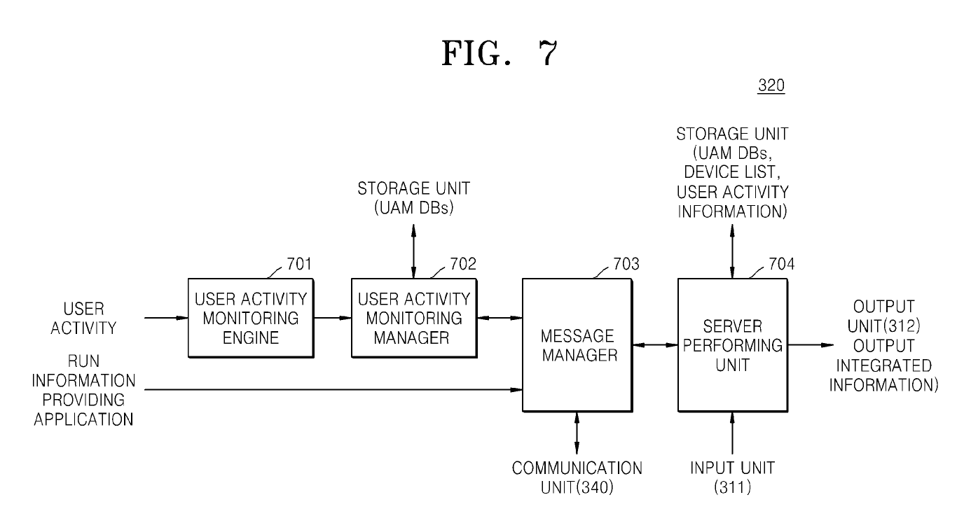

The processor 320 of FIG. 3 is includes elements as illustrated in FIG. 7, based on the software structure of FIG. 4. FIG. 7 is a block diagram of the processor 320 based on the software structure of FIG. 4, according to an embodiment of the present invention, but the present invention is not limited thereto.

Referring to FIG. 7, the processor 320 includes a user activity-monitoring engine 701, a user activity-monitoring manager 702, a message manager 703, and a service-performing unit 704.

The user activity-monitoring engine 701 monitors user activity in the device 300 of FIG. 3, similarly to the user activity-monitoring engine 403 of FIG. 4.

The user activity-monitoring manager 702 stores particular information regarding content and/or information, which is obtained by monitoring user activity by the user activity-monitoring engine 701, in the user activity monitoring DBs 405 of FIG. 4 of the storage unit 330, and transmits the particular information to the message manager 703, similarly to the user activity-monitoring manager 404 of FIG. 4.

If an information-providing application according to an embodiment of the present invention is run, the message manager 703 communicates with an external device via the communication unit 340 to determine a connection state between devices. The message manager 703 transmits information about the connection state to the service-performing unit 704. Determining of the connection state includes device authentication for device grouping. Device authentication is performed using user ID information described above with reference to FIG. 1.

When receiving particular information (metadata) regarding content and/or information from the user activity-monitoring manager 702, the message manager 703 transmits the particular information to a device connected to the device 300 via the communication unit 340, similarly to the message manager 406 of FIG. 4. When particular information (metadata) regarding the content and/or information produced according to user activity in an external device is received from the external device via the communication unit 340, the message manager 703 transmits the particular information to the service-performing unit 704.

The service-performing unit 704 performs operations of the information providing service 407 and the information-providing application 410 described above with reference to FIG. 4. Based on the information about the connection state received from the message manager 703, the service-performing unit 704 produces a device list and stores the device list in the storage unit 330. Furthermore, the service-performing unit 704 receives particular information about content and/or information, which is produced according to user activity in an external device, from the message manager 703, and stores the particular information in the user activity manager DBs 405 in the storage unit 330.

The service-performing unit 704 produces the user activity information 409 that is integrated information by sorting particular information stored in the user activity manager DBs 405 of the storage unit 330, according to a predetermined criterion, and then outputs the user activity information 409 via the output unit 312. If no device is connected to the device 300 via the communication unit 340 or only content and/or information produced by monitoring user activity in the device 300 is collected, then the particular information stored in the user activity manager DBs 405 of the storage unit 330 includes only particular information about content and/or information produced according to user activity monitored by the user activity-monitoring manager 702.

If information is received via the input information, based on integrated information output via the output unit 312, the service-performing unit 704 performs an operation corresponding to the received information.

The storage unit 330 of FIG. 3 stores a program and sources for running an application that executes a method of providing information, according to an embodiment of the present invention. The resources include the resource 401, the user activity monitoring DBs 405, the device list 408, and the user activity information 409 illustrated in FIG. 4.

The communication unit 340 exchanges a message or data via the network 120. If the network 120 is based on a wireless LAN or a wireless communication module as described above, the communication unit 340 exchanges a message or data, using the wireless LAN or the wireless communication module.

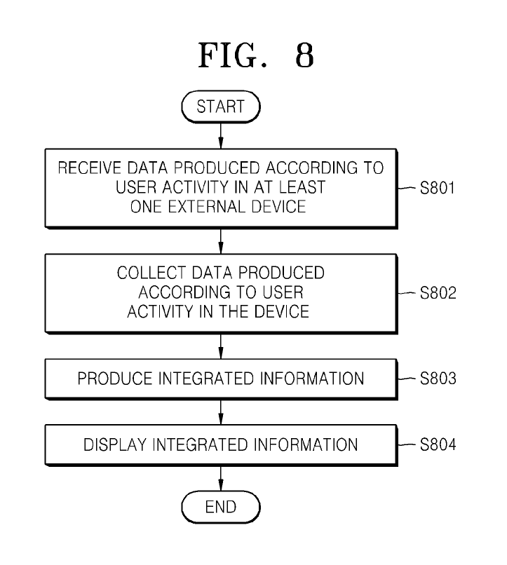

The processor 320 of FIG. 3 operates as illustrated in FIG. 8. FIG. 8 is a flowchart illustrating a method of providing information, according to an embodiment of the present invention. In particular, FIG. 8 illustrates information based on information shared between multi-devices is provided.

Referring to FIG. 8, the processor 320 receives data produced according to user activity in at least one external device in step S801. The at least one external device is a device that is connected to, for example, the device 300 of FIG. 3 via the network 120 of FIG. 1, and that is currently running an application according to an embodiment of the present invention. If the device 300 is the first device 110_1 of FIG. 1, then the external device is at least one device from among the second to n^{th} devices 110_2 to 110_{—}n of FIG. 1. The user activity is monitored as described above with reference to FIGS. 1 and 2. The data produced according to the user activity is particular information about content and/or information produced according to the user activity, and is referred to as metadata or user activity information of the content and/or information.

The processor 320 then collects data produced according to user activity in the device 300 in step S802. This data is particular information about content and/or information produced according to the user activity, and is referred to as metadata of the content and/or information. The device 300 is a local device, and the user activity is as described above with reference to FIGS. 1 and 2.

An order of performing steps 801 and 802 is reversed since data produced according to user activity is received or collected according to a point in time at which the user activity occurs. In other words, if the user activity occurred in the device 300 before the user activity occurs in the external device, then step S802 is performed before step S801 is performed.

The processor 320 then produces integrated information by sorting the data received in step S801 and the data collected in step S802 according to a predetermined criterion in step S803. The predetermined criterion provides fast accessibility to content and/or information that is likely to be used by a user, and includes a recent point of time, a frequency of use, or user preference.

The processor 320 then displays the integrated information on the output unit 312 in step S804. The integrated information displayed on the output unit 312 is as illustrated in one of FIGS. 9A to 9M. FIGS. 9A to 9M illustrate screen images each containing integrated information, according to embodiments of the present invention.

FIG. 9A illustrates a screen image that contains integrated information about data based on particular information about content and/or information produced according to user activity, displayed on a region 901 of the output unit 312 of FIG. 3, according to an embodiment of the present invention.

Referring to FIG. 9A, numbers assigned to sub-regions of the region 901 denote an order in which the integrated information is sorted. For example, a sub-region assigned “1” displays integrated information about data based on content and/or information that is the most likely to be used by a user and a sub-region assigned “16” displays integrated information about data based on content and/or information that is the least likely to be used by the user, from among the displayed integrated information.

The integrated information displayed on the region 901 is sorted according to a predetermined criterion, regardless of category. That is, the integrated information displayed on the region 901 is not sorted by category. The predetermined criterion is at least one from among those described above with respect to step S803 of FIG. 8. If the predetermined criterion is a user activity that has occurred recently, then the integrated information displayed on the sub-region assigned “1” is the integrated information about data based on content and/or information produced according to user activity that has occurred recently, from the integrated information displayed on the region 901. The integrated information displayed on the region 901 is summary information based on particular information about content and/or information produced according to user activity, and includes a thumbnail.

The integrated information displayed on the region 901 is a result of integrating information based on the data collected in step S802 of FIG. 8 and information based on the data received from an external device in step S801 of FIG. 8. For example, if the device 300 is connected to the second device 110_2 via the network 120, the device 300 is the first device 110_1, the first device 110_1 and the second device 110_2 are running an application according to an embodiment of the present invention, and a user of the first device 110_1 wants to use information in both the first device 110_1 and the second device 110_2, then integrated information based on particular information about the content and/or information produced according to user activity in the first device 110_1 and particular information about content and/or information produced according to user activity in the second device 110_2, is displayed on the region 901. For example, in region 901, the integrated information displayed on the sub-region assigned “1” is information based on data received from the second device 110_2, the integrated information displayed on a sub-region assigned “2” is information based on data collected from the first device 110_1, and the integrated information displayed on a sub-region assigned “3” is the information based on the data collected from the first device 110_1.

FIG. 9B illustrates a screen image containing the integrated information of FIG. 9A together with ID information thereof, displayed on a region 902 of the output unit 312 of FIG. 3, according to another embodiment of the present invention. Referring to FIG. 9B, the ID information regarding the integrated information is respectively displayed on sub-regions assigned “1-1”, “2-1”, “3-1”, “4-1”, “5-1” . . . and “16-1” of region 902 of output unit 312. For example, the screen image is created in such a manner that the ID information regarding of the integrated information is displayed above the integrated information thereof. Each of the ID information regarding the integrated information include at least one from, for example, the name of a device that provides the integrated information and information regarding time when the integrated information is provided.

FIG. 9C illustrates a screen image containing integrated information based on collected data is divided into two pages, e.g., an A page and a B page, and each page is individually displayed on an entire region 903 of the output unit 312 of FIG. 3, according to another embodiment of the present invention. Referring to FIG. 9C, the A page displayed on the output unit 312 is switched to the B page by using either a function of moving between the A page and the B page at a predetermined speed or a drag-and-drop function. The integrated information illustrated in FIG. 9C is integrated information obtained by sorting data received from a device connected to a local device and data collected from the local device according to a predetermined criterion, regardless of category, and is expressed in the form of a thumbnail of corresponding content or information.

Similarly to FIG. 9C, FIG. 9D illustrates a screen image containing integrated information arranged regardless of category is divided into two pages, e.g., an A page and a B page, and each page is displayed on an entire region 904 of the output unit 312 of FIG. 3, according to another embodiment of the present invention. However, referring to FIG. 9D, although information received or collected according to a predetermined criterion and regardless of category is respectively displayed in numbered sub-regions of the entire region 904, as in FIG. 9C, information based on highest-priority data belonging to each category is respectively displayed in sub-regions 905, 906, 907, and 908 of the entire region 904. The highest-priority data is data that is highly likely to be used by a user.

The sub-regions 905 to 908 are set to be larger than the other sub-regions being respectively assigned “1” to “28” so that the information displayed in the sub-regions 905 to 908 is differentiated from the other integrated information arranged regardless of category. The information displayed in the sub-regions assigned “1” to “28” includes the information displayed in the sub-regions 905 to 908.

Similarly to FIG. 9D, FIG. 9E illustrates a screen image containing a result of integrating information arranged regardless of category and information of data based on highest-priority content or information belonging to each category is displayed on an entire region 909 of the output unit 312 of FIG. 3, according to another embodiment of the present invention. Compared to FIG. 9D, in the screen image of FIG. 9E, ID information of each category is assigned to each of the information based on the data based on the highest-priority content or information belonging to each category. In the entire region 909 of FIG. 9E, a thumbnail displayed in a sub-region 910 is a thumbnail of highest-priority content belonging to a picture category. Reference letter “P” denotes ID information representing the picture category. A thumbnail displayed in a sub-region 911 is a thumbnail of highest-priority content belonging to a video category. Reference letter “V” denotes ID information representing the video category. A thumbnail displayed in a sub-region 912 is a thumbnail of highest-priority content belonging to an audio category. Reference letter “A” denotes ID information representing the audio category. A thumbnail displayed in a sub-region 913 is a thumbnail of highest-priority content belonging to a web category. Reference letter “W” denotes ID information representing the web category. The ID information of each category may also be displayed in the form of an icon, but is not limited to the form of the initial or icon.

FIG. 9F illustrates content is played based on a screen image that contains integrated information and is displayed on the output unit 312 of FIG. 3, as illustrated in FIG. 9E, according to another embodiment of the present invention. Referring to FIG. 9F, if a screen image 930 containing integrated information is displayed on the output unit 312, and a user taps ID information P representing a picture category included in a sub-region 921 of the screen image, as indicated by reference numeral “931”, then the processor 320 of FIG. 3 switches the displayed screen image 930 to a screen image 932 containing thumbnails (or summary information) of data belonging to the picture category. When scrolling is performed on the screen image 932, the processor 320 switches the screen image 932 displayed on the output unit 312 to a screen image 933 to display thumbnails (or summary information) of the other data belonging to the picture category. When a sub-region assigned “11” is selected in the screen image 933, the processor 320 requests that a device that provides content corresponding to the selected region provide the content, and plays the content when the device provides the content to the processor 320. Thus, the provided content is displayed on the output unit 312, as indicated by reference numeral “934”. If the device that provides the content corresponding to the sub-region assigned “11” of the screen image 933 is a local device, then the processor 320 detects the content from the local device, plays the content, and then displays a screen image 934.

FIG. 9G illustrates a screen image containing multi-summary information, according to another embodiment of the present invention. In particular, FIG. 9G illustrates integrated information arranged regardless of category and integrated information arranged according to category are separately displayed on the output unit 312 of FIG. 3. The integrated information arranged regardless of category is included in the integrated information arranged according to category. In other words, the integrated information that is arranged regardless of category and displayed on a region 945 is included in the integrated information that is arranged according to category and displayed on a region 947.

In FIG. 9G, a region 941 is an indicator bar region in which an application according to an embodiment of the present invention is in a logged in state. In the region 941, an icon corresponding to the application that is run is displayed.

In a region 942, memo summary information is displayed. If a criterion for arrangement is “recent”, then information about a date and time when a memo that has recently been made and stored and a first line of the memo is displayed. For example, “2011 Aug. 6, Saturday, 1:12 p.m., Chest Press 50.2” is displayed as memo summary information in the region 942.

A region 943 is a schedule display region, in which the name, date and time information of a schedule is displayed. For example, schedule information including a date and time when an application according to an embodiment of the present invention is to be run is displayed in the region 943.

In a region 944, information about a device connected to a local device is displayed. For example, the number and connection states of devices connected to the local device to run an application installed in the local device according to an embodiment of the present invention is displayed. The region 944 is a region displaying icons corresponding to the connected devices.

A region 945 is a region in which N pieces of integrated information that are not categorized according to content are displayed, and is referred to as an integrated view area. If a criterion of integration is “recent”, then the region 945 is referred to as a new screen area. In the region 945, information based on data about content and/or information that is highly likely to be used by a user from among content and/or information produced according to user activity in a multi-device, is displayed ahead of the other information. Thus, in the region 945, information 945_1 displayed in front of the other information is based on data of content and/or information that is the most likely to be used by the user, and information 945_{—}n displayed following the other information is based on data of content and/or information that is the least likely to be used by the user. Integrated information displayed in the region 945 is arranged as illustrated in FIG. 9A or 9B.

In a region 946, content ID information is displayed. For example, title information of content, e.g., a picture, video, audio, and a website, is displayed in the region 946. The content ID information includes title information of content. When a piece of the content ID information is selected, a screen image containing a collection of thumbnails (or summary information) of content or information belonging to a category corresponding to the selected information is displayed as illustrated in FIG. 9H.

FIG. 9H illustrates a screen image displayed on the output unit 312 of FIG. 3 when multi-summary information is displayed and content ID information is selected, according to another embodiment of the present invention. Referring to FIG. 9H, if a screen image 951, such as that shown in FIG. 9G, is displayed on the output unit 312 and a user taps “Picture” denoting ID information of a picture category as indicated by reference numeral 952, then the processor 320 of FIG. 3 switches the screen image 951 displayed on the output unit 312 to a screen image 953 containing thumbnails (or summary information) of data belonging to the picture category. If scrolling is performed on the screen image 953, the processor 320 switches the screen image 953 displayed on the output unit 312 to a screen image 954 to display thumbnails (or summary information) of the other data belonging to the picture category. When a sub-region assigned “11” is selected in the screen image 954, the processor 320 requests that a device that provides content corresponding to the sub-region assigned “11” provide the content, and plays the content when receiving the content from the device. The content is then displayed on the output unit 312, as indicated by reference numeral “955”. If the device that provides the content corresponding to the sub-region assigned “11” in the screen image 954 is a local device, then the processor 320 detects the content from the local device, plays the content, and displays a screen image 955.

In the region 947 of FIG. 9G, summary information of content arranged according to category is displayed. In the region 947, thumbnails of content and/or information is displayed in such a manner that content and/or information that is the most likely to be used by a user is arranged first and content and/or information that is the least likely to be used by a user is arranged last. Thumbnails P1, V1, A1, and W1 of content and/or information that are arranged at a first level according to category are thumbnails of content or information that are determined to be the most likely to be used by the user from among content or information belonging to various categories. When a user vertically performs scrolling in the region 947, the processor 320 changes thumbnails corresponding to categories to be displayed in the region 947 according to a direction of the scrolling. For example, if scrolling is performed upward when thumbnails corresponding to categories are displayed in the region 947 as illustrated in FIG. 9G, the thumbnails P1, V1, A1, and W1 disappear and thumbnails P3, V3, A3, and W3 are instead displayed in the region 947. When scrolling is performed downward when thumbnails P2, P3, V2, V3, A2, A3, W2, and W3 are displayed in the region 947, the thumbnails P1, P2, V1, V2, A1, A2, W1, and W2 are displayed in the region 947.

Referring to FIG. 9G, in a region 948, titles of applications are displayed. When a title is selected from among the titles, a screen image, such as the screen image 953 of FIG. 9H, which contains icons corresponding to applications that can be selected is displayed.

Referring to FIG. 9G, in a region 949, a list of applications is displayed. In FIG. 9G, for convenience of explanation, the applications included in the list of applications are illustrated with “App1”, “App2”, “App3”, and “App4”, but icons corresponding to the applications are instead displayed. Furthermore, applications installed in a local device, and applications that are installed in an external device but are not installed in the local device are displayed to be differentiated from one another. If a criterion for arrangement is “recent”, a list is displayed including recently used applications. If an application that was downloaded and installed within a week starting from a current date is included in the list of applications, then an indication such as an asterisk is added to the application “App3”, representing that this application is a new one. If scrolling is horizontally performed in the region 949, the processor 320 changes information regarding applications displayed in the region 949, as in the region 947.

Similarly to FIG. 9G, FIG. 9I illustrates a screen image containing multi-summary information from a multi-device, according to another embodiment of the present invention. However, referring to FIG. 9I, information is horizontally displayed in an integrated view region 961 and an application information region 962, as in FIG. 9G, but content or information belonging to various categories is vertically displayed.

FIG. 9J illustrates a screen image containing multi-summary information from a multi-device, according to another embodiment of the present invention, in which all information that includes information displayed in an integrated view region 963 is horizontally displayed.

FIG. 9K illustrates a screen image containing multi-summary information from a multi-device, according to another embodiment of the present invention. Referring to FIG. 9K, information is displayed in an integrated view region 964, as in FIG. 9G, and information arranged according to category and application information are displayed horizontally below the integrated view region 964.

FIG. 9L illustrates a screen image containing multi-summary information from a multi-device, according to another embodiment of the present invention. Referring to FIG. 9L, an integrated view region is provided as in the entire region 904 of FIG. 9E, and multi-summary information except for information arranged based on category is displayed as illustrated in FIG. 9G.

FIG. 9M illustrates a screen image containing multi-summary information in a multi-device, according to another embodiment of the present invention. Referring to FIG. 9M, all multi-information as illustrated in FIG. 9L is displayed horizontally.

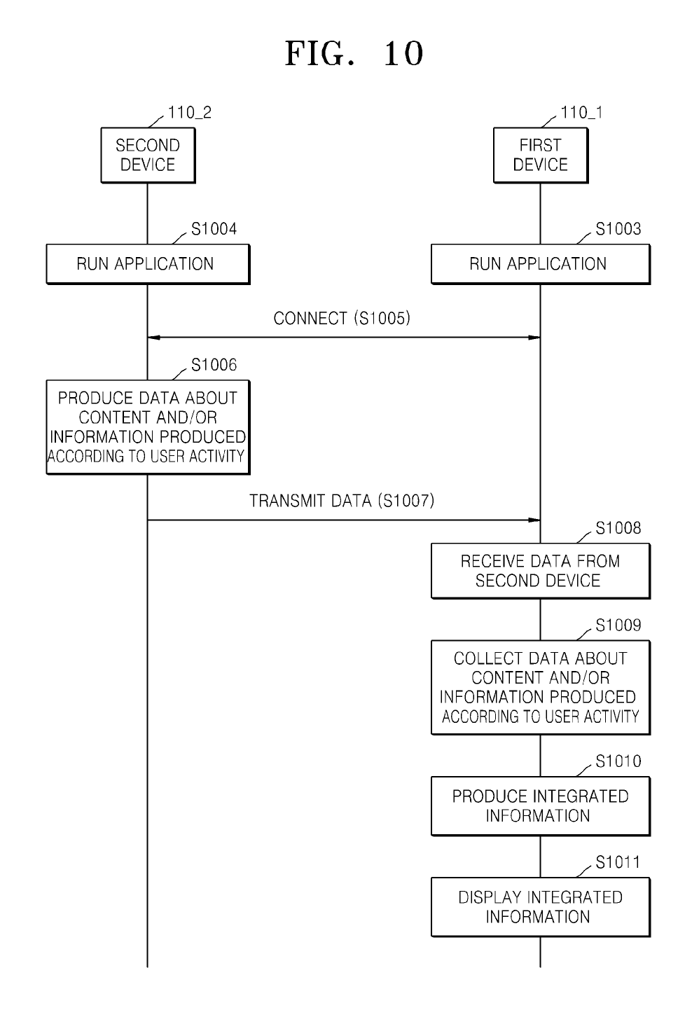

FIG. 10 is a flowchart illustrating steps performed between two devices, based on the flowchart of FIG. 8, according to an embodiment of the present invention. Particularly, FIG. 10 illustrates steps performed between the first device 110_1 and the second device 110_2 of FIG. 1, in which the first device 110_1 is a local device and the second device 110_2 is an external device. The first device 110_1 may have a plurality of external devices as described above with reference to FIG. 1, but for convenience of explanation, FIG. 10 illustrates that only the second device 110_2 is connected to the first device 110_1.

Referring to FIG. 10, the first device 110_1 runs an application according to an embodiment of the present invention in step S1003 and the second device 110_2 runs the application in step S1004. The first device 110_1 and the second device 110_2 are then connected to one another in step S1005. The second device 110_2 then produces data about content and/or information produced according to user activity in the second device 110_2 in step S1006. The second device 110_2 then transmits the data to the first device 110_1 in step S1007.

The first device 110_1 receives the data from the second device 110_2 in step S1008. The first device 110_1 then collects data about content and/or information produced according to user activity therein, from the first device 110_1 itself in step S1009. The first device 110_1 then produces integrated information based on the data received from the second device 110_2 and the data collected from the first device 110_1 itself, as in step S803 of FIG. 8 in step S1010. Thus, the integrated information is produced by arranging the received data and the collected data based on a predetermined criterion. Thereafter, the first device 110_1 displays the integrated information on the output unit 312 of FIG. 3 in step S1011.

FIG. 10 illustrates user activity occurs in both the first device 110_1 and the second device 110_2. However, when user activity occurs in only the second device 110_2, the integrated information includes information based on data about content and/or information produced according to the user activity in the second device 110_2. When user activity occurs in only the first device 110_1, the integrated information includes information based on data about content and/or information produced according to the user activity in the first device 110_1.

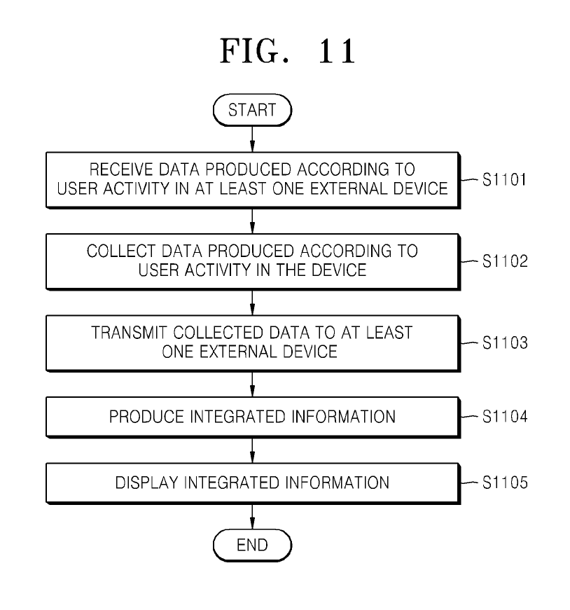

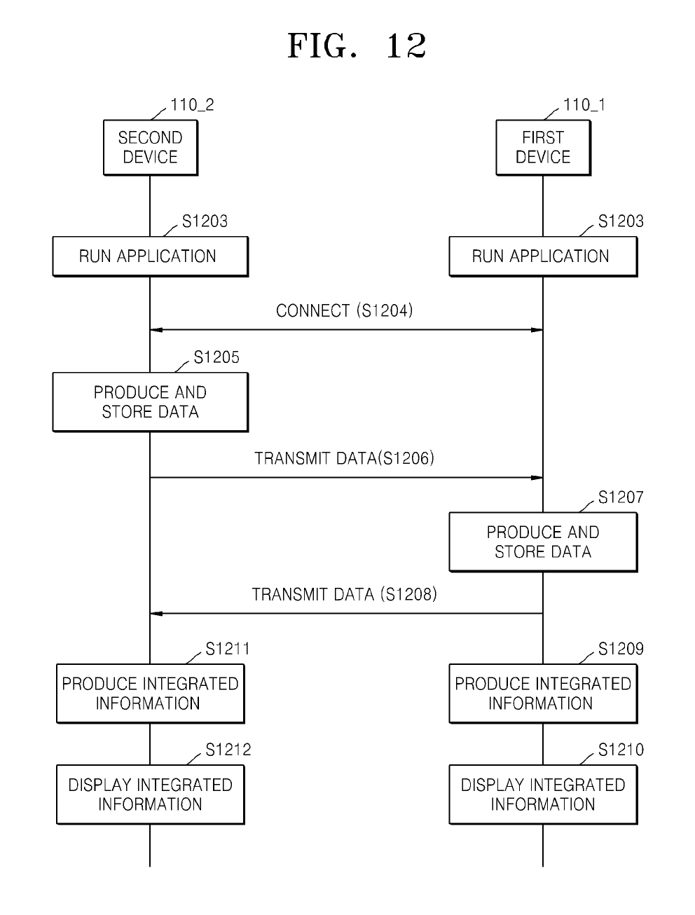

The processor 320 of FIG. 3 operates as illustrated in FIG. 11. FIG. 11 is a flowchart illustrating a method of providing information, according to another embodiment of the present invention. Compared to the method of FIG. 8, FIG. 11 further includes transmitting data collected from the device 300 of FIG. 3 to an external device. Steps S1101, S1102, S1104, and S1105 of FIG. 11 are the same as steps S801 to S804 of FIG. 8 and thus will not be described.

Referring to FIGS. 3 and 11, the processor 320 transmits the data collected from the device 300 to the external device connected to the device 300 via the communication unit 340 in step S1103. Step S1103 is performed before step S1101 is performed according to a point in time at which user activity occurs in the device 300. According to the method of FIG. 11, integrated information displayed on the output unit 312 of the device 300 may also be displayed on an output unit of the external device.

FIG. 12 is a flowchart illustrating steps performed between two devices, based on the flowchart of FIG. 11, according to another embodiment of the present invention. FIG. 12 illustrates the first device 110_1 and the second device 110_2 of FIG. 1 are connected, as in the method of FIG. 10. Steps S1203 to S1207, S1209, and S1210 of FIG. 12 are the same as steps S1003 to S1011 of FIG. 10 and thus will not be described.

Referring to FIG. 12, the second device 110_2 produces integrated information based on data received from the first device 110_1 and data produced in the second device 110_2 in step S1211. In step S1211, the integrated information is produced, as in S1010 of FIG. 10. Then, the second device 110_2 displays the integrated information on an output unit (not shown) of the second device 110_2 in step S1212.

Thus, the same integrated information is displayed in the first device 110_1 and the second device 110_2. If all of the plurality of first to nth devices 110_1 to 110_{—}n of FIG. 1 run an application according to an embodiment of the present invention and are connected to one another, then integrated information based on data about content and/or information being produced according to user activities in the plurality of first to nth devices 110_1 to 110_{—}n is displayed on all the plurality of first to nth devices 110_1 to 110_{—}n.

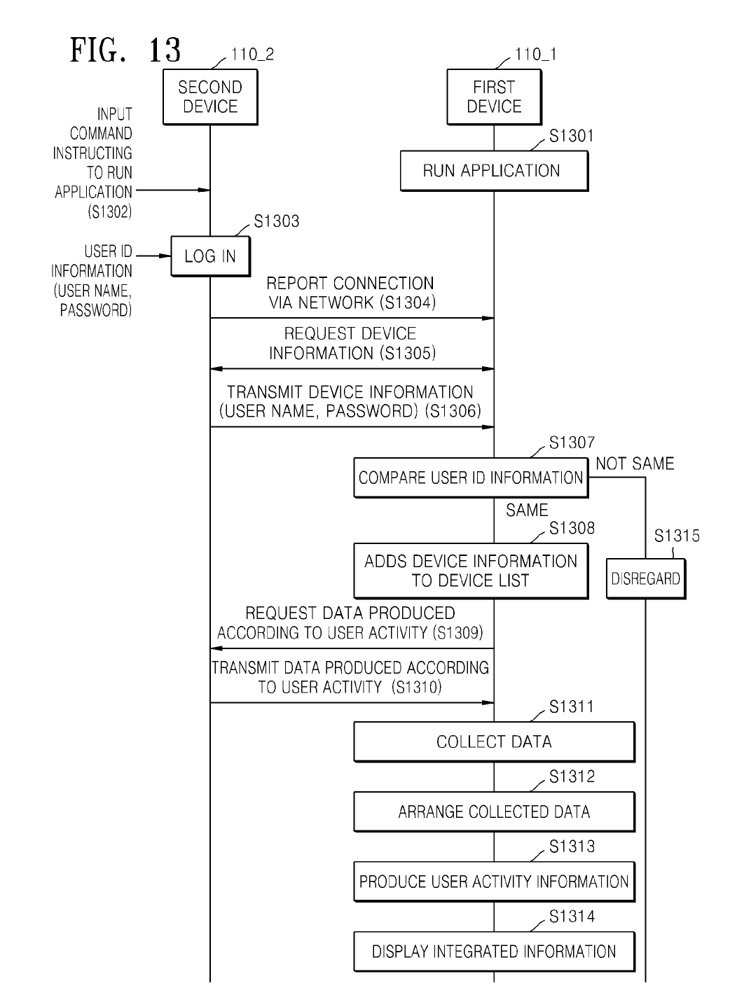

FIG. 13 is a flowchart illustrating steps performed between two devices, in a method of providing information according to an embodiment of the present invention. In particular, FIG. 13 illustrates information is provided using device grouping. For convenience of explanation, FIG. 13 illustrates that only the first device 110_1 and the second device 110_2 are connected to one another.

Referring to FIG. 13, while the first device 110_1 runs an application according to an embodiment of the present invention in step S1301, if a command that instructs to run the application is input to the second device 110_2 in step S1302 and the second device 110_2 logs in to the application by inputting user ID information in step S1303, then the second device 110_2 reports that the second device 110_2 itself is connected to the first device 110_1 via the network 120, to the first device 110_1 in step S1304. The user ID information includes the name and password of a user.

The first device 110_1 then requests that the second device 110_2 provide device information thereof in step S1305. Thereafter, the second device 110_2 transmits the device information that includes user ID information to the first device 110_1 in step S1306. The first device 110_1 then compares the transmitted user ID information with user ID information that was input to the first device 110_1 to log in to the application in step S1307.

If a result of the comparing performed in step S1307 determines that the two pieces of the user ID information are the same, the first device 110_1 adds the device information about the second device 110_2 to a device list that the first device 110_2 itself manages in step S1308. The first device 110_1 then requests that the second device 110_2 provide data produced according to user activity in the second device 110_2 in step S1309. The second device 110_2 then transmits the data about content and/or information, which is produced according to user activity and stored in the second device 110_2 itself, to the first device 110_1, in response to the request from the first device 110_1 in step S1310. The data about content and/or information, which is produced according to user activity and stored in the second device 110_2, means that all content and/or information collected whenever user activity occurs in the second device 110_2.

The first device 110_1 then collects data about content and/or information produced according to user activity in the first device 110_1 itself and the data about content and/or information produced according to user activity in the second device 110_2 in step S1311.

The first device 110_1 then arranges the collected data according to a predetermined criterion in step S1312, and then produces user activity information in step S1313. The predetermined criterion include a point in time at which user activity occurs, a frequency of using content and/or information, user preference for the content and/or information, and the like, as described above with reference to FIG. 1. The user activity information includes the integrated information described above. Thereafter, the first device 110_1 displays the integrated information as described above with reference to any one of FIGS. 9A to 9M in step S1314. A manner in which the user activity information is displayed is selected by a user but is set as a default.

If the result of the comparing performed in step S1307 determines that the two pieces of the user ID information are not the same, the first device 110_1 disregards the report from the second device 110_2 in step S1315. Thus, the second device 110_2 is not included in a group to which the first device 110_1 belongs, and the first device 110_1 does not collect data about content and/or information produced according to user activity in the second device 110_2.

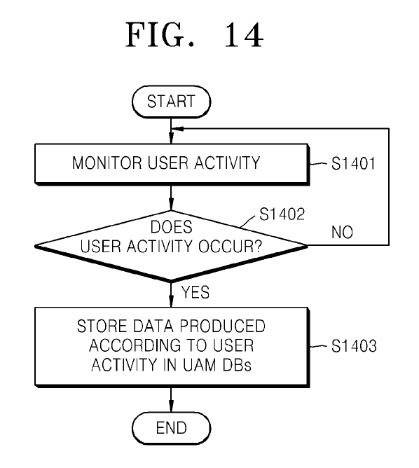

FIG. 14 is a flowchart illustrating a process of storing data produced according to user activity, in a method of providing information, according to an embodiment of the present invention. The method of FIG. 14 is performed by the processor 320 of FIG. 3. The method of FIG. 14 is performed in step S802 of FIG. 8, step S1009 of FIG. 10, step S1102 of FIG. 11, step S1207 of FIG. 12, or step S1311 of FIG. 13.

Referring to FIG. 14, the processor 320 monitors whether user activity occurs when the device 300 of FIG. 3 uses a function that needs user activity to be monitored as described above with reference to FIG. 4 in step S1401. Examples of the function have been described above with reference to FIG. 1.

If a result of the monitoring determines that user activity occurs, then the processor 320 stores data about content and/or information produced according to the user activity in the user activity monitoring DBs 405 of the storage unit 330 in step S1403.

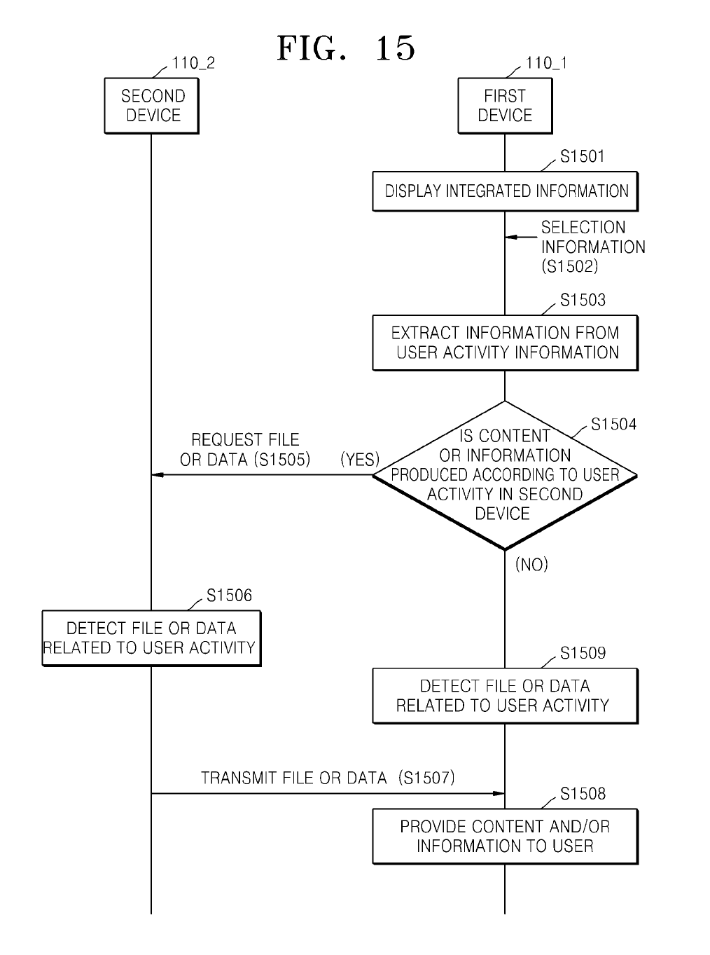

FIG. 15 is a flowchart illustrating a process of using content or information based on integrated information, in a method of providing information, according to an embodiment of the present invention. The method of FIG. 15 is performed after step S804 of FIG. 8, step S1011 of FIG. 10, step S1105 of FIG. 11, step S1210 of FIG. 12, step S1212 of FIG. 12, or step S1314 of FIG. 13 is performed. For convenience of explanation, it is assumed that the method of FIG. 15 is performed between the first device 110_1 and the second device 110_2 of FIG. 1.

Referring to FIG. 15, while the first device 110_1 displays integrated information produced based on user activity in the first device 110_1 itself and user activity in the second device 110_2 in step S1501, selection information based on the integrated information displayed on the first device 110_1 is received in step S1502. The first device 110_1 then extracts information regarding the selection information from user activity information stored in the storage unit 330 of FIG. 3 in step S1503. The extracted information includes metadata.

If it is determined that the extracted information determines that the selection information is content or information stored in the second device 110_2 in step S1504, then the processor 320 of FIG. 3 requests that the second device 110_2 provide a file or data corresponding to the selection information in step S1505. The requested file or information is referred to as content or information. Thereafter, the second device 110_2 detects the file or data related to user activity in the second device 110_2 itself, in response to the request received in step S1505 in step S1506. The second device 110_2 then transmits the detected file or data to the first device 110_1 in step S1507. Thereafter, the first device 110_1 displays the file or data so that a user may view the file or data in step S1508.

If the extracted information determines that the selection information is content or information produced according to user activity in the first device 110_1 in step S1504, then a file or data corresponding to the selection information is detected from the first device 110_1 in step S1509. Thereafter, first device 110_1 displays the file or data so that the user may view the file or data in step S1508.

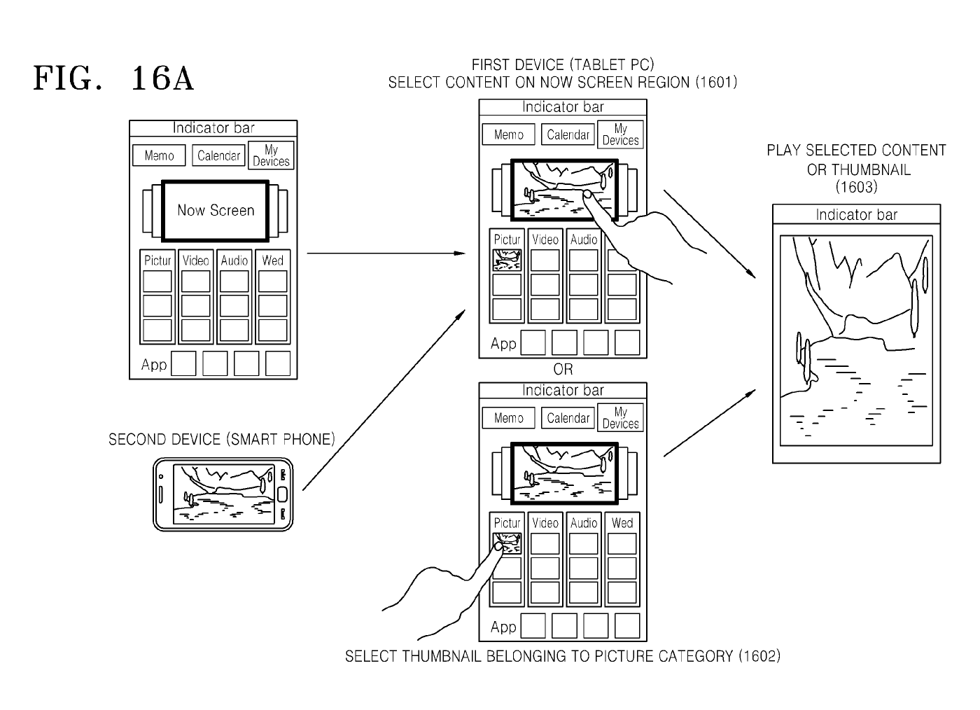

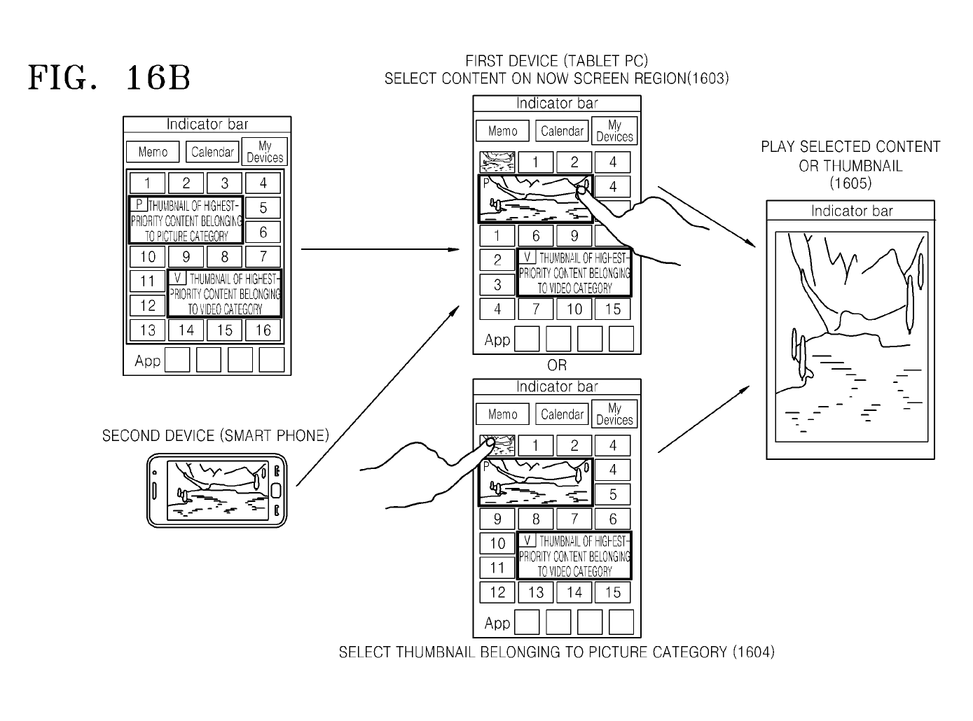

FIGS. 16A and 16B illustrate screen images via which content produced according to user activity is provided to a user, based on the method of FIG. 15, according to embodiments of the present invention.

FIG. 16A illustrates a photograph captured by the second device 110_2 of FIG. 1 is displayed on the first device 110_1 of FIG. 1 when the first device 110_1 is a tablet PC and the second device 110_2 is a smartphone.

Specifically, if summary information (metadata) regarding the photograph captured by the second device 110_2 is transmitted to the first device 110_1 and is then displayed as highest-priority content on an integrated information screen region (or an integrated view region) on the first device 110_1, then the summary information of the highest-priority content displayed on the integrated information screen region is selected in step 1601 or summary information of the highest-priority content belonging to a picture category is selected in step 1602. Thereafter, the first device 110_1 requests that the second device 110_2 provide data about the selected summary information. When receiving the requested data from the second device 110_2, the first device 110_1 reproduces the data to display a screen image on the output unit 312 of the first device 110_1 in step 1603. The screen image is displayed on an entire screen of the output unit 312.

Thus, a user directly views the photograph captured by the second device 110_2 on the first device 110_1. The integrated information screen region of the first device 110_1 is referred to as a “nowscreen region” when a criterion for arranging integrated information is “recent”. When data about content and/or information produced according to new user activity in the second device 110_2 or the first device 110_1 is obtained, the highest-priority data displayed on the integrated information screen region is updated with the obtained data.

FIG. 16B illustrates a photograph captured by the second device 110_2 is displayed on the first device 110_1 when the first device 110_1 is a tablet PC, the second device 110_2 is a smartphone, and information is displayed on an integrated information screen region on the first device 110_1 as illustrated in FIG. 9E.

Specifically, if summary information of highest-priority content belonging to a picture category, which is displayed on the integrated information screen region (or integrated view region), is selected in step 1603 or summary information displayed in a sub-region (a thumbnail region) of a region displaying information that is not arranged according to category is selected in step 1604, then the first device 110_1 requests that the second device 110_2 provide content or information corresponding to the selected summary information. Upon receiving the content or information from the second device 110_2, the first device 110_1 plays the content or information to display a screen image on the output unit 312 of the first device 110_1 (step 1605. Thus, a user may view the photograph, which is displayed on the second device 110_2, on the first device 110_1 having a larger screen than that of the second device 110_2. The screen image output to the output unit 312 is displayed on the entire screen of the output unit 312.

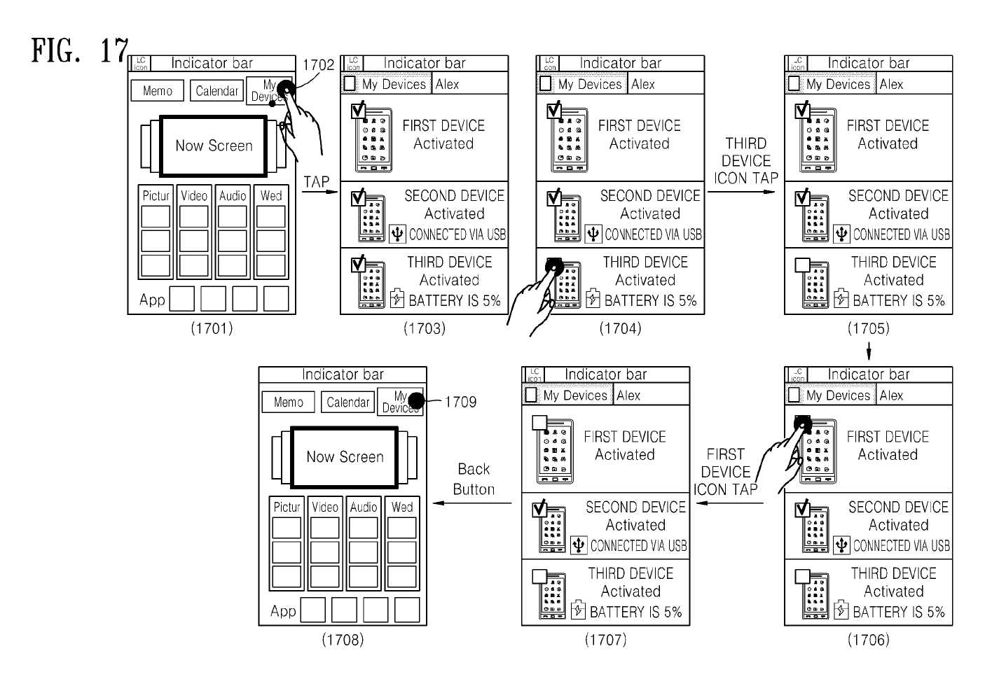

FIG. 17 illustrates a process of processing information regarding connected devices, in a method of providing information, according to an embodiment of the present invention. The process of FIG. 17 is performed by the processor 320 of FIG. 3. In particular, FIG. 17 illustrates a function of excluding one device from among three devices, e.g., the first to third devices 110_1 to 110_3 of FIG. 1, which are connected to one another.

Referring to FIG. 17, when a user taps a region 1702 displaying information regarding a device connection state on a screen image 1701 indicating that the three devices are connected, the screen image 1701 displayed on the output unit 312 is switched to a screen image 1703.

It is noted from the screen image 1703 that the user is currently using the first device 110_1, and the second device 110_2 and the third device 110_3 are connected to the first device 110_1 and are thus in an activated state. In order to exclude data produced according to user activity in the third device 110_3 from the screen image 1703, the third device 110_3 taps the third device 110_3 displayed on a screen image 1704. Then, the screen image 1704 displayed on the output unit 312 is switched to a screen image 1705 to display the third device 110_3 in a deactivated state. Thus, the data produced according to user activity in the third device 110_3 is deleted from integrated information displayed on the output unit 312 of the first device 110_1. However, although the data produced according to user activity in the third device 110_3 is not included in the integrated information displayed on the first device 110_1, the first device 110_1 continuously receives the data produced according to user activity from the third device 110_3 as long as the first device 110_1 is connected to the third device 110_3.

If a “My Devices” icon corresponding to the first device 110_1 is tapped on the screen image 1705 as shown in a screen image 1706, the screen image 1705 displayed on the first device 110_1 is switched to a screen image 1707 displaying the first device 110_1 in the deactivated state. Thus, data provided from the first device 110_1 is also excluded from the integrated information displayed on the output unit 312 of the first device 110_1. Here, ‘my device’ should be a local device described above.

In other words, when a back button is tapped on the screen image 1707, the screen image displayed on the output unit 312 of the first device 110_1 is switched to a screen image 1708. In the screen image 1708, only data produced according to user activity, which is provided from the second device 110_2, is displayed. Thus, the number of devices displayed on a region 1709 displaying a device connection state is changed to one.

When a criterion for device connection is changed as illustrated in FIG. 17, additional information about a connected device is provided. The additional information include information representing a device state, e.g., “connected via USB” and “battery is 5%” as illustrated in FIG. 17.

Although user selection is performed by tapping in the embodiments of FIGS. 9, 16A, 16B, and 17, user selection is not limited thereto.

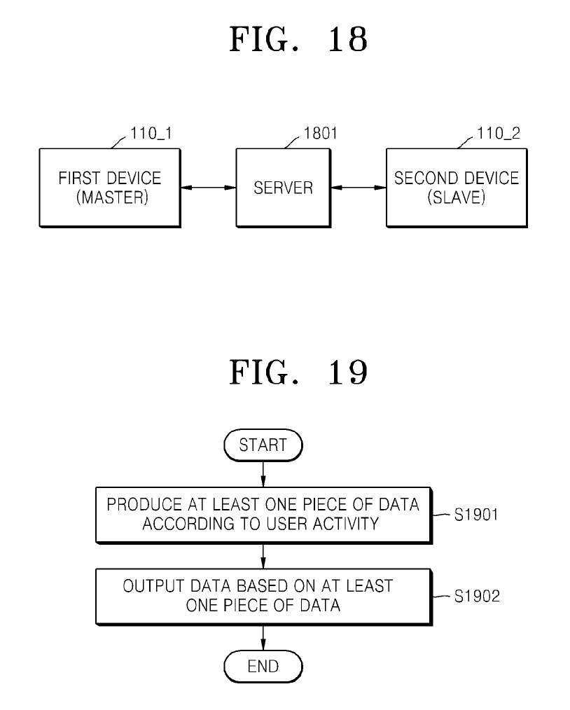

FIG. 18 is a block diagram of a network consisting of a plurality of devices, according to another embodiment of the present invention. Referring to FIG. 18, whenever content and/or information is produced according to user activity in a second device 110_2, the content and/or information is pushed together with data (metadata) thereof to a server 180 and the server 1801 stores the pushed data. When a first device 110_1 requests that the server 1801 provide all such data at once or periodically requests that the server 1801 provide such data, the server 1801 provides the first device 1101_1 with the data about the content and/or information produced according to user activity in the second device 110_2, which is stored in the server 1801 itself, or may push data to the first device 1101_1 whenever the data is pushed to the server 1801 itself from the second device 110_2. Then, the first device 110_1 may output-integrated information based on the pushed data, and request that the server 1801 provide content and/or information corresponding to information selected, based on the output-integrated information. Then, the server 1801 provides the first device 110_1 with the content and/or information corresponding to the selected information, and the first device 110_1 outputs the provided content and/or information. For convenience of explanation, FIG. 18 illustrates the first device 110_1 and the second device 110_2 are connected to the server 1801, but n devices is connected to the server 1801 as illustrated in FIG. 1.

In FIG. 18, the first device 110_1 and the second device 110_2 is respectively referred to as a master and a slave, based on a criterion for providing information according to user activity. FIG. 18 illustrates the second device 110_2 provides information according to user activity therein to the first device 110_1.

The processor 320 of FIG. 3 operates according to a flowchart of FIG. 19. FIG. 19 is a flowchart illustrating a method of providing information, according to another embodiment of the present invention. In particular, FIG. 19 illustrates information based on data produced according to user activity in one device is output via the device. For example, in the method of FIG. 19, information based on data produced according to user activity in the first device 110_1 of FIG. 1 is output via the first device 110_1.

Referring to FIGS. 3 and 19, when user activity in the device 300 is monitored, the processor 320 produces at least one piece of data based on the monitored user activity in step S1901. The at least one piece of data is the same as the at least one piece of data produced according to user activity, which is described above with reference to FIG. 1.

Then, the processor 320 arranges information based on the at least one piece of data, according to a predetermined criterion and then outputs a result of the arranging to the output unit 321 in step S1902. The predetermined criterion has been described above with reference to FIGS. 1 to 17. Thus, the information output to the output unit 321 is displayed based on one of the screen images illustrated in FIGS. 9A to 9M, but the present invention is not limited thereto.

The information output to the output unit 321 includes multi-summary information or summary information according to a multi-operation of the device 300. Thus, when the processor 320 operates according to the method of FIG. 19, the information included in the screen images of FIGS. 9A to 9M includes information based on data produced in the device 300 but does not include information based data produced according to user activity in another device or an external device.

However, if the device 300 is connected to at least one external device via the communication unit 340 while the processor 320 operates according to the method of FIG. 19, then the processor 320 operates according to a method of providing integrated information in an environment in which a plurality of devices are connected to one another as described above with reference to FIGS. 1 to 17. The method of FIG. 19 may further include a process of storing data produced as described above with reference to FIG. 14 and a process of detecting and playing content and/or information corresponding to information selected by a user based on output information as described above with reference to FIG. 15.

A program for performing methods of providing information according to embodiments of the present invention can be embodied as computer readable code in a computer readable medium. Here, the computer readable medium is any recording apparatus capable of storing data that is read by a computer system, e.g., a Read-Only Memory (ROM), a Random Access Memory (RAM), a Compact Disc (CD)-ROM, a magnetic tape, a floppy disk, an optical data storage device, and so on. The computer readable medium can be distributed among computer systems that are interconnected through a network, and the present invention is stored and implemented as computer readable code in the distributed system.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. A method of providing information, the method comprising:
producing a piece of data based on user activity in a device; and
displaying information based on the piece of data on the device.

2. The method of claim 1, further comprising:
receiving a piece of data based on the user activity from an external device,
wherein displaying the information comprises displaying integrated information based on the piece of data produced based on the user activity in the device and the piece of data received from the external device, on the device.

3. The method of claim 2, further comprising:
transmitting the piece of data produced based on the user activity in the device to the external device.

4. The method of claim 2, wherein the external device and the device belong to a group.

5. The method of claim 4, wherein the group is set based on user identification information.

6. The method of claim 4, further comprising:
if a device belonging to the group is set to be deactivated, deleting information regarding the deactivated device from the displayed information.

7. The method of claim 2, further comprising:
receiving a selection signal for selecting a piece of information from the displayed information;
if the selected piece of information is provided from the external device, requesting that the external device provide content or information corresponding to the selected piece of information; and
if the requested content or information is received from the external device, the device plays the received content or information.

8. The method of claim 2, further comprising:
if the external device is added to a group to which the device belongs, the device requesting that the external device provide the piece of data produced based on the user activity; and
receiving the piece of data produced based on the user activity from the external device.

9. The method of claim 2, wherein the external device comprises a server for providing data produced based on the user activity in the device.

10. The method of claim 1, wherein the piece of data produced based on the user activity comprises metadata of content and information produced based on the user activity, and
the displayed information comprises multi-summary information or summary information.

11. The method of claim 1, wherein the user activity is monitored when a function of obtaining content and information is performed, and
the displayed information is arranged based on a criterion for providing a fast access path to content and information that are likely to be used by a user.

12. The method of claim 11, wherein the criterion comprises at least one of a point in time at which the user activity occurs, a frequency of use of the content or information, and user preference for the content or information.

13. The method of claim 1, wherein displaying the information comprises displaying information that is not arranged based on category.

14. The method of claim 1, wherein displaying the information comprises separately displaying first information that is not arranged based on category and second information that is arranged based on category.

15. The method of claim 14, wherein displaying the information further comprises:
displaying category identification information for each category in a region where the second information is displayed; and
if a piece of category identification information is selected from the category identification information, replacing the displaying information with information belonging to a category corresponding to the selected category identification information.

16. The method of claim 1, wherein displaying the information comprises displaying the information in such a manner that highest-priority information belonging to each category is differentiated from information that is not arranged based on category.

17. The method of claim 16, wherein the highest-priority information belonging to each category comprises category identification information for each category, and
if a piece of category identification information is selected from category identification information for each category, then the displaying of the information comprises replacing the displayed information with information belonging to a category corresponding to the selected category identification information.

18. The method of claim 1, wherein the information comprises at least one of memo information, schedule information, photo information, music storing and/or reproducing information, web page accessing information, application information, moving picture storing and/or reproducing information, and device information regarding a device providing integrated information.

19. The method of claim 1, further comprising storing the piece of data produced based on the user activity in the device.

20. The method of claim 1, further comprising:
receiving a selection signal for selecting a piece of information from the displayed information; and
playing content or information corresponding to information selected based on the selection signal.

21. A device for providing information, the device comprising:
a processor for collecting a piece of data produced based on user activity and producing information based on the collected data; and
an output unit for outputting the information.

22. The device of claim 21, further comprising:
a communication unit for communicating with an external device; and
a storage unit for storing the collected data,
wherein, if the piece of data produced based on the user activity is received from the external device via the communication unit, then the processor produces integrated information based on the received data and the collected data, and outputs the integrated information to the output unit.

23. The device of claim 22, wherein the processor transmits the collected data to the external device via the communication unit.

24. The device of claim 22, wherein the device and the external device belong to a group.

25. The device of claim 24, wherein the group is set based on user identification information.

26. The device of claim 24, wherein, if a device belonging to the group is set to be deactivated, the processor deletes information regarding the deactivated device from the integrated information output via the output unit.

27. The device of claim 22, wherein, if a selection signal for selecting a piece of information from among the integrated information and information selected based on the selection signal is provided from the external device, then the processor requests that the external device provide content or information corresponding to the selected information, via the communication unit, receives the requested content or information from the external device, plays the received content or information, and outputs a result of the playing to the output unit.

28. The device of claim 22, wherein, if the external device is added to a group to which the device belongs, the device requests that the external device provide the piece of data produced based on the user activity, via the communication unit, receives the piece of data produced based on the user activity from the external device, and produces the integrated information, based on the received information.

29. The device of claim 22, wherein the external device comprises a server for providing data produced based on the user activity in a device.

30. The device of claim 22, wherein, if a selection signal for selecting a piece of information from output-integrated information is received, the processor detects content or information corresponding to information selected based on the selection signal from the storage unit, and plays the detected content or information.

31. The device of claim 21, wherein the piece of data produced based on the user activity comprises metadata of at least one of content and information produced based on the user activity, and
the output-integrated information comprises multi-summary information or summary information.

32. The device of claim 21, wherein the processor monitors the user activity when a function of obtaining at least one of content and information is performed, and produces the integrated information by arranging the piece of data produced based on the user activity, based on a criterion for providing a fast access path to at least one of content and information that are likely to be used by a user.

33. The device of claim 32, wherein the criterion comprises at least one of a point in time at which the user activity occurs, a frequency of use of the content or information, and user preference for the content or information.

34. The device of claim 21, wherein the processor produces information that is not arranged based on category, as the information.

35. The device of claim 21, wherein the processor produces the information in such a manner that first information that is not arranged based on category and second information that is arranged based on category are separately displayed.

36. The device of claim 35, wherein the processor produces the information in such a manner that a plurality of pieces of category identification information are displayed in a region where the second information is displayed, and
if a selection signal for selecting a piece of category identification information from the plurality of pieces of category identification information is received, the processor replaces the information displayed on the output unit with information belonging to a category corresponding to the selected category identification information.

37. The device of claim 21, wherein the processor produces the information in such a manner that highest-priority information belonging to each category is differentiated from information that is not arranged based on category.

38. The device of claim 37, wherein the highest-priority information belonging to each category comprises category identification information thereof, and
if a selection signal for selecting a piece of category identification information from the plurality of pieces of category identification information based on the highest-priority information belonging to each category is received, then the processor replaces the information displayed on the output unit with information belonging to a category corresponding to the selected category identification information.

39. The device of claim 21, wherein the output information comprises at least one of memo information, schedule information, photo information, music storing and/or reproducing information, web page accessing information, application information, moving picture storing and/or reproducing information, and device information regarding a device providing the information.

40. A computer readable recording medium having recorded thereon a computer program for executing a method of providing information, the method comprising:
producing a piece of data based on user activity in a device; and
displaying information based on the piece of data on the device.

41. The computer readable recording medium of claim 40, wherein the method further comprises:
receiving a piece of data based on the user activity from an external device, and
displaying the information comprises displaying integrated information based on the piece of data produced based on the user activity in the device and the piece of data received from the external device, on the device.
